(19) United States
(12) Patent Application Publication
(10) Pub. No.: US 2002/0083206 A1
(43) Pub. Date: Jun. 27, 2002

(54) Method and apparatus extending a server to a wireless-router server

(76) Inventor: Dennis Michael Volpano, Salinas, CA (US)

Correspondence Address: GLENN PATENT GROUP, 3475 EDISON WAY, SUITE L, MENLO PARK, CA, 94025, US

(21) Appl. No.: 09/933,775

(22) Filed: Aug. 20, 2001

Related U.S. Application Data
(60) Provisional application No. 60/258,434, filed on Dec. 27, 2000.

(30) Foreign Application Priority Data
Apr. 17, 2001 (US) PCT/US01/12401

(51) Int. Cl. G06F 15/16

(52) U.S. Cl. 709/249

(57) ABSTRACT

A method and apparatus of providing communication between a wireless transceiver and at least one wireline network, wherein a wireless interface possessing a wireline communications port and the wireless transceiver is coupled to a server, wherein the server is further coupled to the wireline network. Certain embodiments preferably include methods to produce a wireless router from a server.

### CROSS-REFERENCE TO RELATED APPLICATIONS

This application claims priority to Provisional patent application Ser. No. 60/258,434 docket number CRAN0002PR, entitled “Wireless Network Appliance”, filed Dec. 27, 2000; and to patent application Ser. No. PCT/U.S.01/12401, docket number CRAN0002P, entitled “Method and Apparatus Extending a Server to a Wireless-Router Server”, filed Apr. 17, 2001.

### BACKGROUND OF THE INVENTION

1. Technical Field

This invention relates to providing a wireless interface as a server device to a server to create a wireless-router server.

2. Description of the Prior Art

FIG. 1 depicts an 802.11 Extended Service Set as found in the prior art.

The components of a wireless Ethernet are defined in the IEEE Standard IEEE802.11 Std-1999. The extended service set (ESS) of a wireless Ethernet comprises a distribution system (DS), mobile stations with wireless Ethernet transceivers (STA), and base stations, also known as access points (AP). A wireless Ethernet transceiver is typically packaged as a Type II PCMCIA card for use in contemporary notebook computers. Each AP is a link-layer (OSI layer 2) bridge between the DS and the STA. A high-rate (11 Mbps) wireless Ethernet standard utilizing Direct Sequence Spread Spectrum (DSSS) modulation is defined in the IEEE802.11b Standard.

The DS is normally a wired Ethernet (IEEE802.3 Standard). An AP behaves like an Ethernet hub or repeater. It relays Ethernet frames from the wired Ethernet to every STA as though the STA were physically attached to the wired Ethernet. It also relays every frame from an STA to the wired Ethernet. Multicast, broadcast, and unicast frames are relayed in both directions. An STA attaches to the DS through exactly one AP at any time. Movement of the STA may cause it to re-attach to the DS through a new AP. This constitutes a handoff of the STA between access points. Because an AP is a link-layer bridge, a handoff succeeds only if the base stations involved belong to the same OSI layer 3 subnet. It is not the responsibility of an AP to route at layer 3. The subnet to which a set of base stations belongs may have a gateway which routes layer 3 datagrams to other layer 3 subnets.

The IEEE802.11 Standard prescribes another form of wireless Ethernet called an Independent Basic Service Set (IBSS). Unlike the ESS, an IBSS has no DS and no AP. Mobile stations communicate directly. An IBSS is often called an ad hoc, or peer-to-peer, wireless network.

A router is characterized by multiple network interfaces. Each interface is associated with a set of destination addresses for devices that can be reached through that interface. The interface also has a unique address used to reference it.

For instance, an Ethernet interface is referenced by a 48-bit, layer 2 (link layer) address. It is also associated with a set of layer 2 addresses that is the set of destination addresses reachable from it. Each destination address corresponds to a device that can be reached via the Ethernet Medium Access Control (MAC) protocol through that physical interface. If Ethernet frames are routed between interfaces based on their destination layer 2 addresses, then routing occurs at layer 2. Layer 2 routers are commonly called switches.

However, routing can also occur at layer 3. When routing occurs at layer 3, each interface has a layer 3 address, and a range of destination layer 3 addresses. Layer 3 datagrams are routed between interfaces based on their destination layer 3 address.

Many routers perform network address translation, which simplifies IP addressing and conserves the IP address space. Network address translation enables private IP internetworks to use non-registered IP addresses to connect to the Internet. Network address translation usually operates on a router connecting two networks together, translating private (globally nonunique) addresses in the internal network into legal addresses before packets are forwarded to another network. Network address translation on a router can be configured to present only one address for the entire internal network to the external network. This essentially hides the entire internal network behind that address and forces all messaging between the external network and internal network to pass through specific communications processes and security measures.

If a physical network interface runs the IEEE802.11 MAC protocol (wireless Ethernet) and another runs the IEEE802.3 MAC protocol (wired Ethernet) then there are two ways to bridge the interfaces. One is at layer 3, and the other is at layer 2. The layer 3 bridge is called a wireless router. Wireless routers are not governed by the IEEE802.11 Standard. An AP is a layer 2, or link layer, bridge.

There is a wireless router available commercially, the SMC Networks Wireless Broadband Router. It has a wireless network transceiver, four physical ports, and a non-extensible set of services including firewall security and network address translation. The wireless network transceiver is integrated into the product, making its removal impossible.

FIG. 2A shows a typical configuration for a wireless router as found in the prior art.

The router has one interface connected to a DSL modem, another connected to a wired Ethernet hub, and a third physical interface that is a wireless Ethernet transceiver. Address translation done at the router permits multiple wired hosts, connected via the hub, and mobile stations, connected via the wireless transceiver, to share the single layer 3 address of the DSL interface. The wired hosts and mobile stations are behind the router in that wired hosts and mobile stations are allowed to connect to hosts on layer 3 subnets outside the subnet to which the layer 3 address of the DSL interface belongs. However, hosts on these other subnets cannot initiate a connection to any of the wired hosts or mobile stations. Network connections then are unidirectional due to network address translation.

Software that implements the functionality of an AP according to the IEEE802.11 Standard is available from Neesus Datacom. It is called PC-AP because it runs on a PC under Windows 95. It has three parts: an NDIS driver that controls a wireless Ethernet PC card, an NDIS driver for an IEEE802.3 wired Ethernet card, and a Windows protocol shim that bridges the two drivers at layer 2. Compaq has an OEM license to use PC-AP in its WL300 product.

FIG. 2B depicts a server 100 as disclosed in the prior art coupling to a collection of at least one wireline network client 114.

Server 100 is controlled by computer 150 operating server 100 based upon program system 400 and client list 190, which reside in accessibly coupled 152 memory 160. Program systems are discussed herein as comprised of program steps residing in such memory, which are accessed and used to operate server 100 by the actions of computer 150 based upon the accessed program steps.

Server 100 includes at least one wireline communications port 140 communicatively coupled 112 with wireline network 110. A wireline client 114 is communicatively coupled 116 with network 110 providing physical transport path 116 via 110 via 112 communicatively coupling wireline network client 114 and server 100.

In certain situations, server 100 may communicatively couple 222 via network 110 with upgrade server 220 as shown by communications path 112-110-222.

In certain situations, server 100 may include a second wireline communications port 210 coupled 212 to modem 214, which in turn couples 216 to second network 218. Upgrade server 220 may couple 224 to second network 218, providing a second or alternative communicative coupling path 212-214-216-218-224 between server 100 and upgrade server 220.

In these situations, sometimes upgrade server 220 is provided 226 an upgrade package 228. Upgrade server 220 presents upgrade package 228 to server 100 via one of the communicative couplings, where it is further presented to computer 150.

Computer 150 uses the presented upgrade package to modify program system 400 and/or client list 190. Client list 190 may be altered either in terms of active entries or the structure of such entries. Altering program system may include any of the following. Adding capabilities to program system 400, including device drivers as well as communications functions. Modifying existing capabilities may include adding new virus definitions to a firewall.

As used herein server 100 refers to at least one computer 150, with no particular size requirement, having one or more network interfaces 140 and/or 210 through which clients 114 (other computers) access message based services on server 100. Such services include, but are not limited to, TCP/UDP protocol-based services. They may include, but are not limited to, file provisioning, print spooling, electronic mail, web content, datagram forwarding, and proxy services, among others. A server is extensible in that as part of its normal administration, new services can be enabled, and others disabled. A server is not normally tasked with routing even though server operating systems like Linux and FreeBSD can route at layer 3. Such a server 100 includes servers as manufactured by Sun Microsystems, such as the Qube 3 Appliance.

Current practice for accessing a server uses technology governed by the IEEE802.11 Standard to place the server in a DS and introduce an AP. Mobile wireless stations access the server indirectly through the AP using either TCP or UDP applications. Because services are TCP/UDP based, an alternative to using an AP to access the server is to use a wireless router instead. With either approach, a second processor, in the AP or router, is required to support mobile stations.

As used herein, a computer refers to at least one of the following: an instruction processing system, an inference engine and a finite state machine. An instruction processing system includes at least one instruction register, whose contents change through the fetching of instructions from a memory accessibly coupled to the computer.

Another example is a server that runs the Dynamic Host Configuration Protocol (DHCP). DHCP allows computers to dynamically discover the addresses of one or more authoritative domain name servers. Such information is also useful to mobile wireless stations.

With a separate server and wireless router, DHCP does not see a mobile station's DHCP_DISCOVER packets because they are broadcast using the limited broadcast address, and a router never forwards a datagram whose destination address is the limited broadcast address. Hence the wireless router must also run DHCP, and maintain its own DHCP configuration file containing the addresses of the same domain name servers found in the DHCP configuration file on the server.

### SUMMARY OF THE INVENTION

The invention includes methods of producing a wireless router from a server. In certain preferred embodiments, only one computer is required, the server's computer. Preferably, the server runs an operating system capable of forwarding layer 3 datagrams between its network interfaces, one of which is the wireless network interface. The invention includes the delivery and installation of the necessary software through upgrade packages and nonvolatile memory components. The upgrade packages may reside on an upgrade server, which provides them to servers for installation.

There is economy in the invention besides eliminating a computer. Administration of the wireless router can be integrated with existing server configuration tasks. This provides opportunities to eliminate redundant processing and network/server administration. For instance, some commercial base stations allow filtering of Ethernet frames based on destination link-layer addresses. This is a capability that may already exist in the kernel running on the server. The tools and user interface of the operating system kernel can be uses to administer filtering across all network interfaces, wired as well as wireless.

As stated above with a separate server and wireless router, DHCP will not see a mobile station's DHCP_DISCOVER packets requiring the wireless router to also run DHCP, and maintain its own DHCP configuration file. This duplication is eliminated with the invention, as there is at most one instance of DHCP running, and only one configuration file.

The extended server merges the functions of a server and a wireless router. Usually they are sold separately as different pieces of hardware with separate operating systems and separate user interfaces for administration. The extended server has only one operating system and a single user interface for administering both the server's services and its wireless access capability.

Unlike any AP on the market today, the extended server is parameterized on the type of modulation. For example, the extended server can use FHSS (Bluetooth), DSSS (IEEE 802.11b) or OFDM (IEEE 802.11a). It is only necessary to use a different wireless network card, which may be coupled to the server in any of a variety of ways, including bus and interface couplings.

There are many applications that demand wireless access to a server and for which neither a server, nor an AP, nor a wireless router alone is sufficient. They include users, who may either be customers or service personnel, placing orders wirelessly in restaurants where menus are stored on the server. Allowing customers to query a database stored on a server wirelessly, such as a library is another example. Yet another example is the delivery of audio and video content from the extended server, located in a kiosk, to automobiles and portable computers.

The extended server can provide Internet access wirelessly to handheld computers and personal digital assistants. It can update itself with new content downloaded periodically, or upon demand, from the Internet or from a site within an Extranet. Other places where the extended server is useful include bookstores, public libraries, coffee shops, and convenience stores. All have in common the need for wireless access to a local repository of information for that site, plus wireless Internet access for information available only through the Internet.

The extended server can decapsulate packets for any communications protocol stack, e.g. WAP or Bluetooth. This facilitates integrating new protocol stacks that run on small wireless devices with existing networks. Interfacing with a new protocol stack is confined to the extended server, and hence to the network perimeter, leaving communication protocols in the existing network unmodified.

One of skill in the art will readily recognize that the embodiments of the invention disclosed herein support more than one wireless interface and that different wireless interfaces further support distinct wireless communications protocols. In a similar fashion, it will be recognized that multiple wireline communications ports can be coupled between the server and multiple wireline networks, possibly possessing different physical transport layers, as well as different messaging protocols.

### BRIEF DESCRIPTION OF THE DRAWINGS

FIG. 1 depicts an 802.11 Extended Service Set as found in the prior art;

FIG. 2A shows a typical configuration for a wireless router as found in the prior art;

FIG. 2B depicts a server 100 as disclosed in the prior art coupling to a collection of at least one wireline network client 114;

FIG. 3A depicts a router supporting communications between a first wireless client 200 and a wireline network 110 using a server 100 operated by computer 150, which is controlled at least in part by program system 1000 residing in memory 160 accessibly coupled 152 to computer 150;

FIG. 3B depicts a router supporting communications between a first wireless client 200 and a wireline network 110 using a server 100 as in FIG. 3A operated by means 1000 for providing communication between transceiver 130 and wireline network 110;

FIG. 3C depicts a refinement of FIG. 3A, with wireless interface 120 coupling via an interface with computer 150 operating server 100 as shown in FIG. 2B, at least partially controlled by program system 1000 residing in memory 160;

FIG. 3D depicts a refinement of FIG. 3A, with wireless interface 120 coupling via an bus coupling 104 with computer 150 operating server 100 as shown in FIG. 2B, at least partially controlled by program system 1000 residing in memory 160;

FIG. 4 depicts a preferred wireless router using a server 100 operated by computer 150 as in FIG. 3A with wireless interface 120 embodied as a wireless PCMCIA card coupled 104 using the PCMCIA bus convention through PCMCIA card reader 170;

FIG. 5 depicts a detail flowchart of program system 1000 of FIG. 4A and means 1000 of FIG. 4B supporting communications between a first wireless client and a wireline network;

FIG. 6A depicts a detail flowchart of program system 1000 of FIG. 4A and means 1000 of FIG. 4B further supporting communications between a wireless client and a wireline network;

FIG. 6B depicts a detail flowchart of operation 1082 of FIG. 6A further showing the wireless client communicating via the wireless coupling;

FIG. 7A depicts a detail flowchart of operation 1022 of FIG. 5 further enabling address translation on the server;

FIG. 7B depicts a detail flowchart of operation 1032 of FIG. 5 further adding the network route for the wireless interface on the server;

FIG. 8A depicts a detail flowchart of operation 1042 of FIG. 5 further making the wireless interface available to at least one wireless client;

FIG. 8B depicts a detail flowchart of operation 1022 of FIG. 5 for enabling address translation on the server;

FIG. 9 depicts a flowchart of operation 2000 of the method of producing a wireless router from a server;

FIG. 10 depicts an alternative flowchart of operation 2000 of FIG. 9 for the method producing a wireless router from a server;

FIG. 11A depicts a detail flowchart of operation 2072 of FIG. 10 for coupling the wireless interface;

FIG. 11B depicts a detail flowchart of operation 2072 of FIG. 10 for coupling the wireless interface;

FIG. 12 depicts a detail flowchart of operation 2142 of FIG. 11B for coupling the wireless interface to the server using the bus coupling;

FIG. 13 depicts a detail flowchart of operation 2152 of FIG. 11B for coupling the wireless interface to the server using the interface coupling;

FIG. 14 depicts a detail flowchart of operation 2222 of FIG. 13 for coupling the wireless interface to the server using the Ethernet interface; and

FIG. 15 depicts a detail flowchart of operation 2232 of FIG. 13 for coupling the wireless interface to the server using the fiber optic interface;

FIG. 16 depicts a detail flowchart of operation 2032 of FIGS. 9 and 10 for enabling address translation on the server; and

FIG. 17 depicts a detail flowchart of operation 2112 of FIG. 10 for running the host configuration protocol.

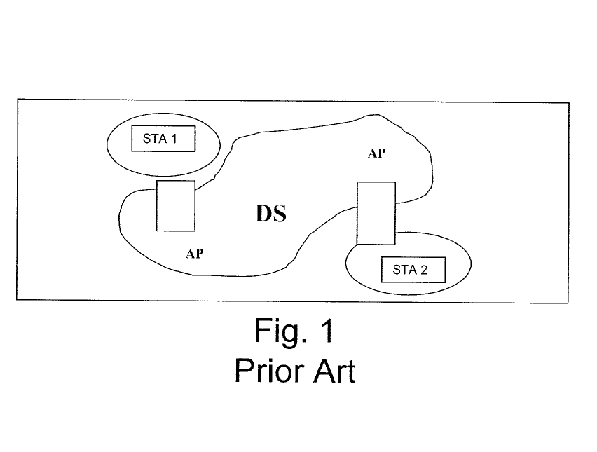

### DETAILED DESCRIPTION OF THE INVENTION

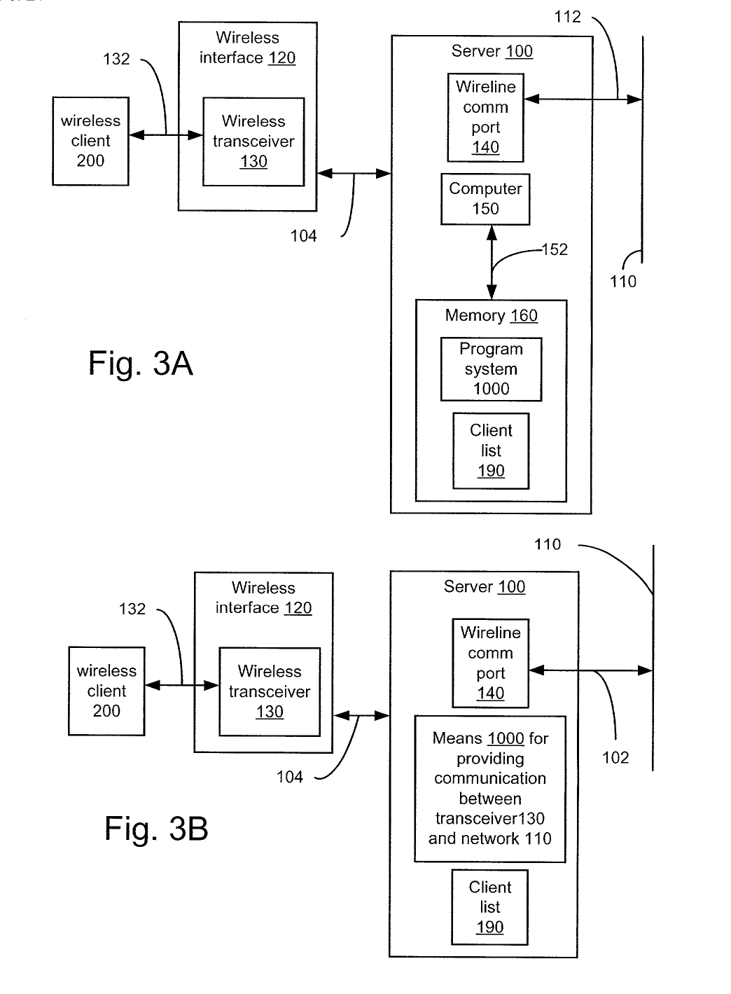

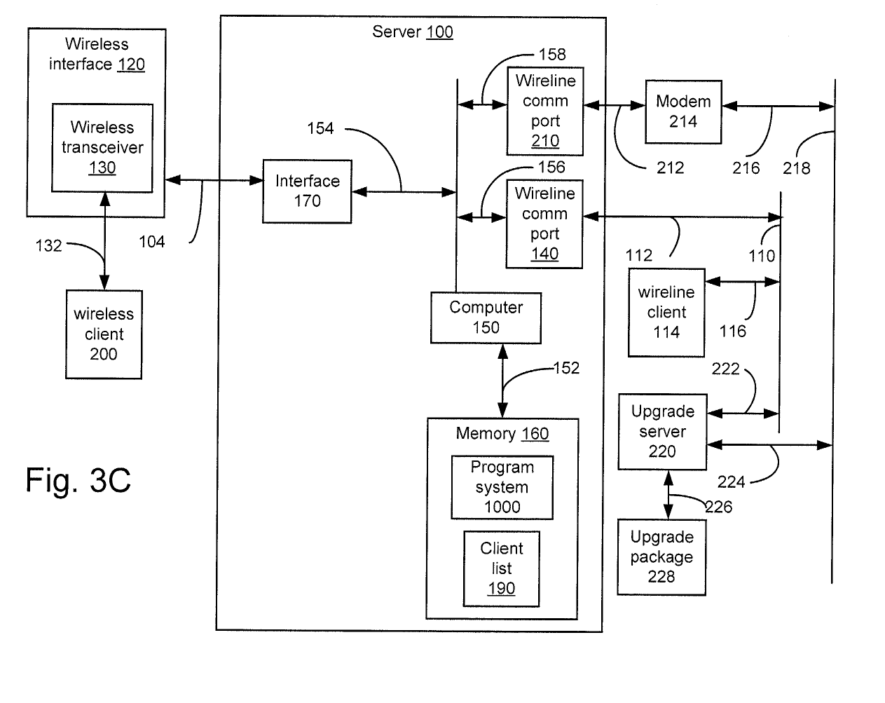

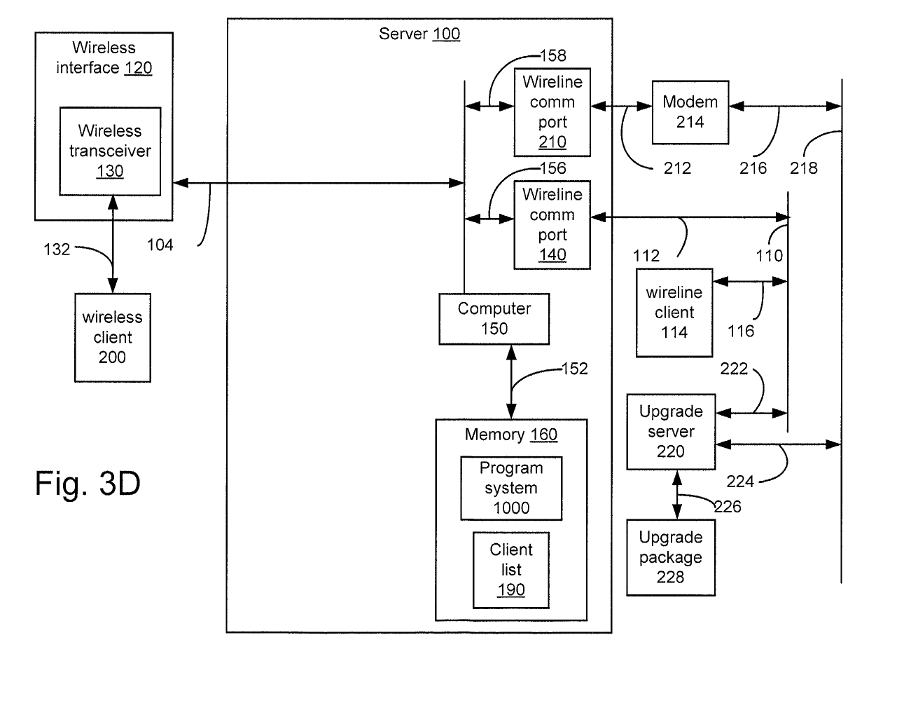

FIG. 3A depicts a wireless router supporting communications between a first wireless client 200 and a wireline network 110 using a server 100 operated by computer 150, which is controlled at least in part by program system 1000 residing in memory 160 accessibly coupled 152 to computer 150.

The system is comprised of a wireless interface 120 coupled 104 to a server 100 which couples 112 via wireline communication port 140 to wireline network 110. The wireless interface 120 possesses a wireless transceiver 130. The wireless interface 120 may preferably couple 104 via a PCMCIA card reader 170 communicatively coupled 154 with computer 150.

The wireline network 110 couples 112 via wireline communications port 140 to the server 100. Note the wireline communications port 140 may include a bus port.

The server is controlled by at least one computer 150 operating the server 100 based upon a program system 1000 comprising program steps residing in memory 160 accessibly coupled 152 with the computer 150.

Wireless transceivers 120 may support at least a message passing wireless communications protocol, further supporting at least layer two messaging communications protocols. Wireless transceivers 120 preferably support at least IEEE 802.11b.

Routers embodied in this invention preferably support layer three datagrams originating from wireless users.

Certain embodiments of the invention include program system 1000 implemented as program steps residing in at least one memory 160 accessibly coupled 152 with computer 150 operating server 100. Memory 160 includes at least one of the following: A non-volatile memory component accessibly coupled with the computer. A volatile memory component accessibly coupled with the computer. A removable non-volatile memory component inserted into a memory component reader coupled with the computer forming an accessible coupling of the removable non-volatile memory component with the computer.

Non-volatile memory components further support a file management system as found in various operating systems including but not limited to versions of UNIX, including LINUX and various forms of Windows.

Removable non-volatile memory components include but are not limited to floppy disks, compact flash, zip disks, CD roms, CD-RW disks and DVD RAMs and DVD ROMs.

Note in that various embodiments of the invention, the server may be a member of the Qube product line, which includes the Qube 3, manufactured and marketed by Sun Microsystems.

Also note that the wireless interface 120 may be a radio network interface.

FIG. 3B depicts a wireless router supporting communications between a first wireless client 200 and a wireline network 110 using a server 100 as in FIG. 3A operated by means 1000 for providing communication between transceiver 130 and wireline network 110.

Means 1000 implements the methods of this invention using operational controls including, but not limited to, instruction processors, inferential engines, neural networks, and finite state machines, which may or may not be one-hot-state encoded. The means for implementing individual steps of the methods of this invention may be differ from one step to another. The means for implementing groups of these steps may use a single control mechanism. Note that in contemporary technology, the preferred means for implementing these operations is as program steps residing in memory, but that even now, when the volume of use of an invention becomes large enough, any or all of the mentioned means have been used to advantage in other systems.

Wireless interface 120 may couple to computer 150 as shown in FIG. 3A by a member of the wireless coupling collection, which includes interface couplings and bus couplings.

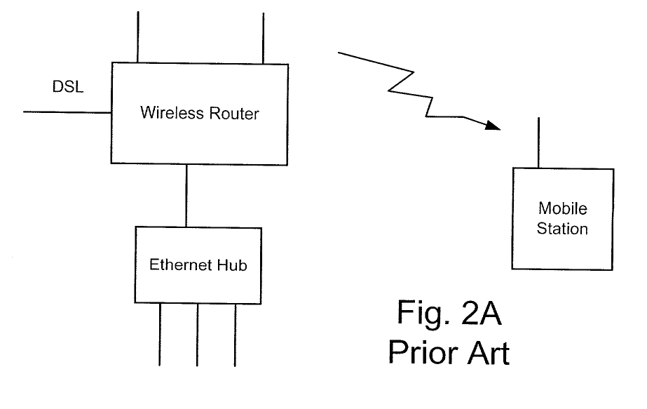

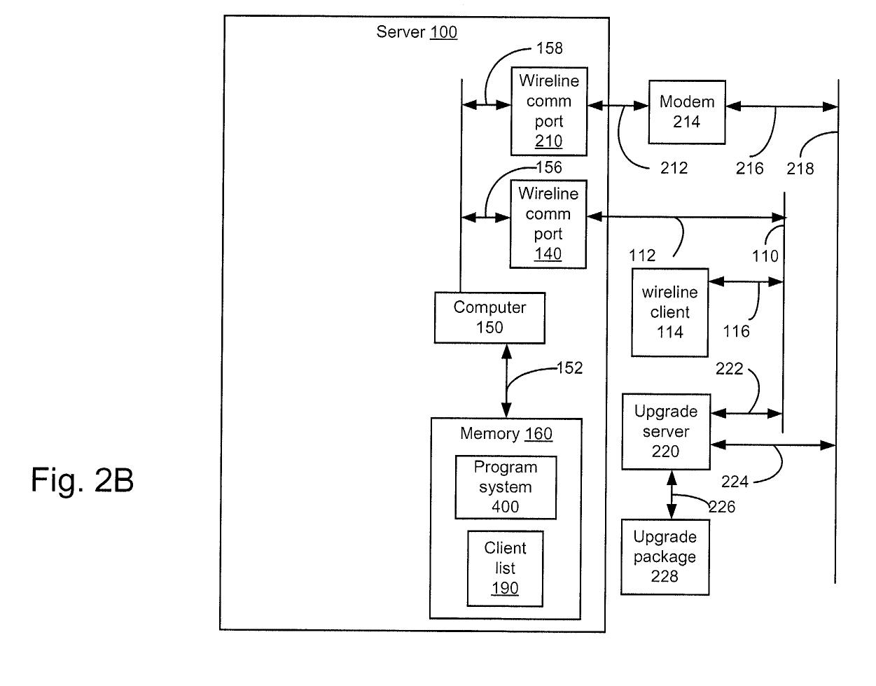

FIG. 3C depicts a refinement of FIG. 3A, with wireless interface 120 coupling via an interface with computer 150 operating server 100 as shown in FIG. 2B, at least partially controlled by program system 1000 residing in memory 160.

Wireless interface 120 couples 104 via interface 170 through 154 to computer 150. By way of example, interface 170 may include, but is not limited to being a member of the following: a USB interface, an Ethernet interface, a fiber optic interface, an ATM interface, a STM interface, and a modem interface.

As used herein, ATM refers to any of the Asynchronous Transfer Mode communications protocols, or variations in such protocols. STM refers to Synchronous Transfer Mode communications protocols herein.

As used herein, a modem refers to a device incorporating the operations of both a modulator and a demodulator performing these operations with respect to at least one physical communications channel. Note that the modulator and demodulator operations, while often symmetrical, need not be symmetrical with respect to each other. By way of example, contemporary ADSL modems typically provide more demodulation capability than modulation capability.

An Ethernet interface as used herein will refer to at least the following: a 1-Base T Ethernet interface, a 10-Base T Ethernet interface, a 100 Base T Ethernet interface, and a gigabit Ethernet interface.

A fiber optic interface as used herein refers to at least the following: a fiber channel compliant interface, an interface to a Time Division Multiplexing fiber optic, an interface to a photonic switch fiber optic, an interface to an optical subcarrier multiplexed fiber optic and an interface to Wavelength Division Mutliplexed fiber optic.

Certain embodiments of the invention include upgrade package 228 containing a version of program system 1000 to reside memory 160.

Upgrade package 228 is accessibly coupled 226 with upgrade server 220 communicatively accessible to computer 150 operating server 100. As shown in FIG. 3C, communications access between server 100 and upgrade server 228 may be through either network 110 or through network 218. The network accessed for communication of the upgrade package may or may not be part of the normal operation of the invention's embodiment as implemented. Upgrade server 228 provides upgrade package 228 to computer 150.

FIG. 3D depicts a refinement of FIG. 3A, with wireless interface 120 coupling via an bus coupling 104 with computer 150 operating server 100 as shown in FIG. 2B, at least partially controlled by program system 1000 residing in memory 160.

Bus coupling 104 as used herein refers to at least the following: a PCI bus coupling, a Compact PCI bus coupling, and an ISA bus coupling.

Typically, a bus is found to have many parallel physical communication channels. These parallel physical communication channels are often implemented as conductive paths embedded in or printed on a substrate.

Typically, an interface today involves a physical transport layer with few or one physical communication channel, such as coaxial cable, twisted wire pairs, and single strand fiber optics. While these distinctions are useful given contemporary deployed technology, research results indicate that at least fiber optic physical transport layers with many bundled physical communication channels have been proven feasible and reliable.

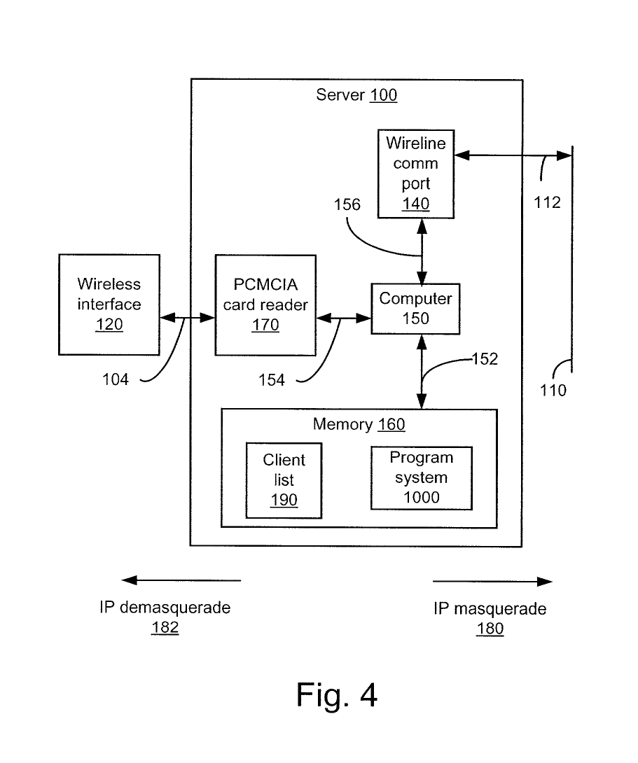

FIG. 4 depicts a preferred wireless router using a server 100 operated by computer 150 as in FIG. 3A with wireless interface 120 embodied as a wireless PCMCIA card coupled 104 using the PCMCIA bus convention through PCMCIA card reader 170.

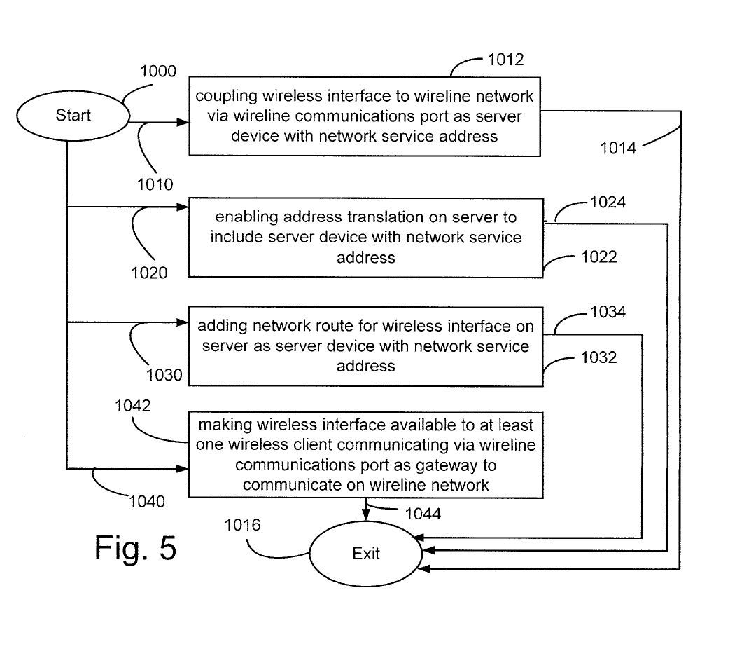

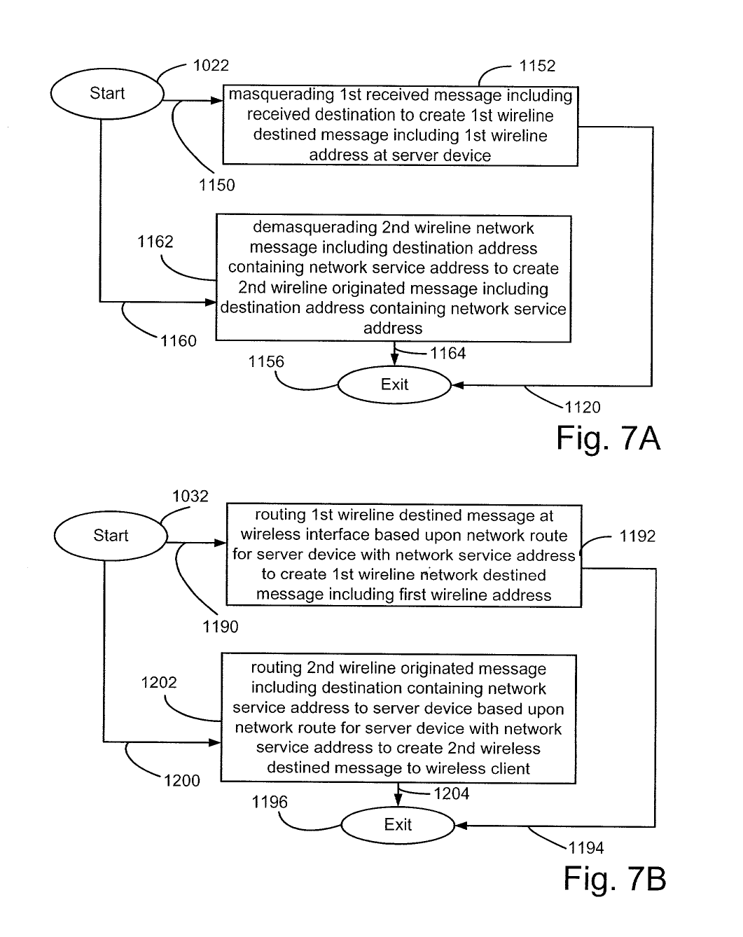

Network address translation is accomplished by running IP masquerade 180, which masquerades traffic from the wireless to the wired interface, and demasquerades 182 return traffic from the wired to the wireless interface. Network address translation is discussed in FIG. 5 as operation 1022. As used herein, masquerading traffic may refer to the use of a single or the use of multiple external addresses for traffic through a wireless router constructed in accordance with this invention. The masquerading and demasquerading operations 180 and 182 are further discussed in FIG. 7A as operations 1152 and 1162, respectively.

This implies that the wireless router 100 forwards layer 3 datagrams to and from mobile wireless clients 200. It is not necessary to perform address translation to extend a server 100 to a wireless router. The key property is that the server 100 be able to forward datagrams. Address translation allows multiple wireless clients 200 to each have a unique unicast layer 3 address and yet all be represented by the server 100 with a single unicast address on the wireline network 110.

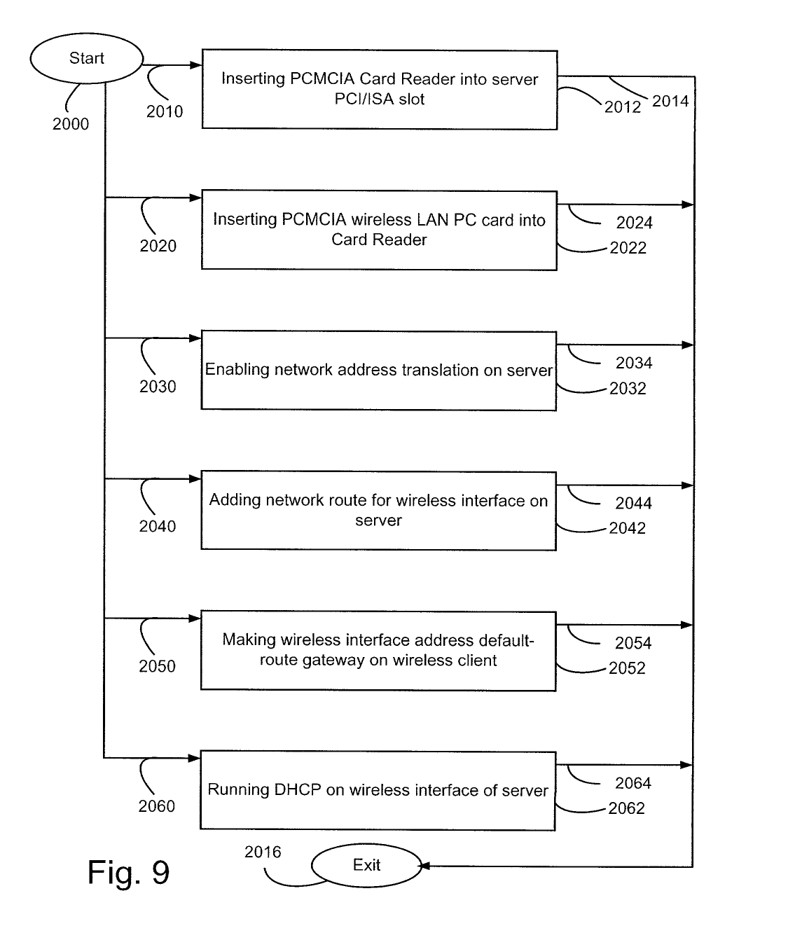

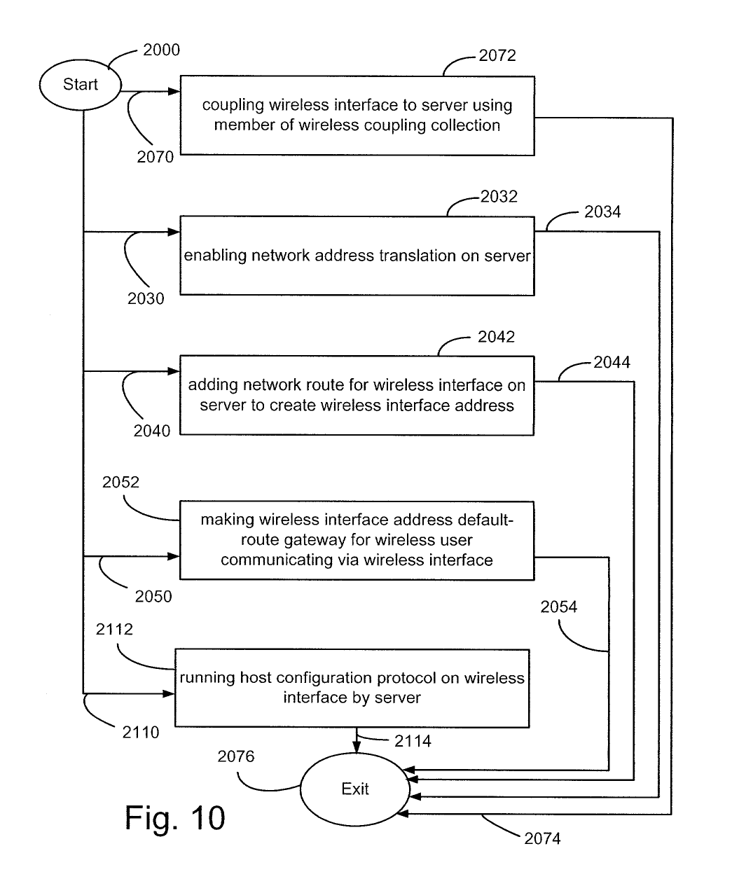

Operation 1032 of FIG. 5 and operation 2032 of FIGS. 9 and 10 involve adding a subnet route to the kernel routing table of the server 100 with the wireless interface 120 as its device.

FIG. 5 depicts a detail flowchart of program system 1000 of FIG. 4A and means 1000 of FIG. 4B supporting communications between a first wireless client and a wireline network.

Arrow 1010 directs the flow of execution from starting operation 1000 to operation 1012. Operation 1012 performs coupling the wireless interface to the wireline network via the wireline communications port as a server device with a network service address. Arrow 1014 directs execution from operation 1012 to operation 1016. Operation 1016 terminates the operations of this flowchart.

Arrow 1020 directs the flow of execution from starting operation 1000 to operation 1022. Operation 1022 performs enabling address translation on the server to include the server device with the network service address. Arrow 1024 directs execution from operation 1022 to operation 1016. Operation 1016 terminates the operations of this flowchart.

Arrow 1030 directs the flow of execution from starting operation 1000 to operation 1032. Operation 1032 performs adding a network route for the wireless interface on the server as a server device with the network service address. Arrow 1034 directs execution from operation 1032 to operation 1016. Operation 1016 terminates the operations of this flowchart.

Arrow 1040 directs the flow of execution from starting operation 1000 to operation 1042. Operation 1042 performs making the wireless interface available to at least one wireless client communicating via the wireline communications port as a gateway to communicate on the wireline network. Arrow 1044 directs execution from operation 1042 to operation 1016. Operation 1016 terminates the operations of this flowchart.

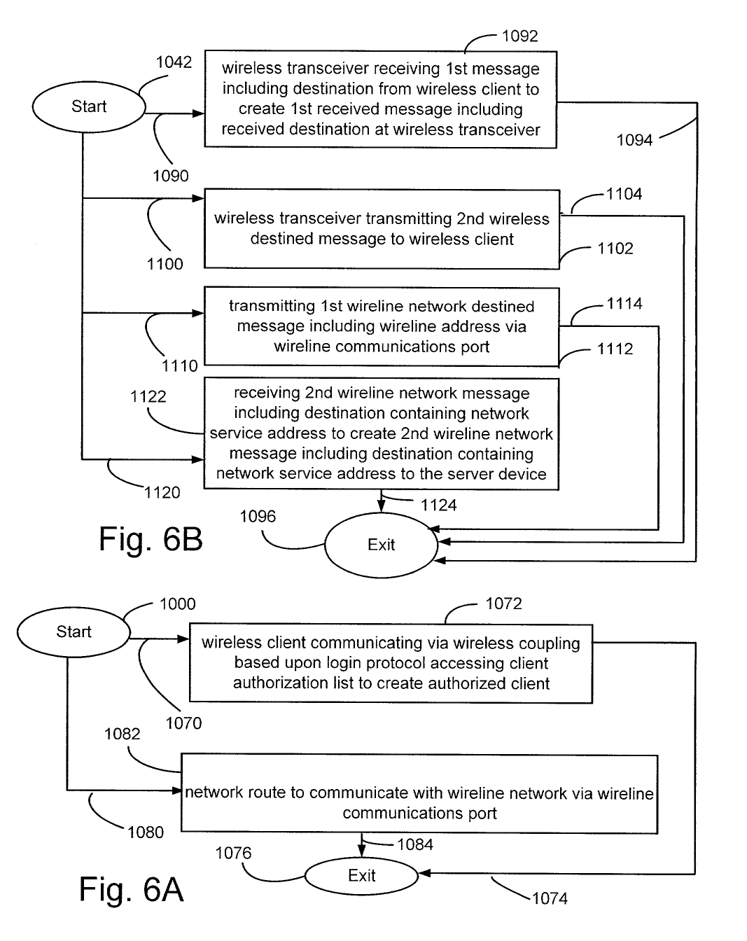

FIG. 6A depicts a detail flowchart of program system 1000 of FIG. 4A and means 1000 of FIG. 4B further supporting communications between a wireless client and a wireline network.

Arrow 1070 directs the flow of execution from starting operation 1000 to operation 1072. Operation 1072 performs a wireless client communicating via the wireless coupling based upon a login protocol accessing a client authorization list to create an authorized client. Arrow 1074 directs execution from operation 1072 to operation 1076. Operation 1076 terminates the operations of this flowchart.

Arrow 1080 directs the flow of execution from starting operation 1000 to operation 1082. Operation 1082 performs the authorized client communicating via the wireless coupling using the network route to communicate with the wireline network via the wireline communications port. Arrow 1084 directs execution from operation 1082 to operation 1076. Operation 1076 terminates the operations of this flowchart.

FIG. 6B depicts a detail flowchart of operation 1042 of FIG. 5 further making the wireless interface available to the authorized client.

Arrow 1090 directs the flow of execution from starting operation 1042 to operation 1092. Operation 1092 performs the wireless transceiver receiving a first message including a destination from the wireless client to create a first received message including the received destination at the wireless transceiver. Arrow 1094 directs execution from operation 1092 to operation 1096. Operation 1096 terminates the operations of this flowchart.

Arrow 1100 directs the flow of execution from starting operation 1042 to operation 1102. Operation 1102 performs the wireless transceiver transmitting a second wireless destined message to the wireless client. Arrow 1104 directs execution from operation 1102 to operation 1096. Operation 1096 terminates the operations of this flowchart.

Arrow 1110 directs the flow of execution from starting operation 1042 to operation 1112. Operation 1112 performs transmitting the first wireline network destined message including the wireline address via the wireline communications port. Arrow 1114 directs execution from operation 1112 to operation 1096. Operation 1096 terminates the operations of this flowchart.

Arrow 1120 directs the flow of execution from starting operation 1042 to operation 1122. Operation 1122 performs receiving a second wireline network message including a destination containing the network service address to create a second wireline network message including the destination containing the network service address to the server device. Arrow 1124 directs execution from operation 1122 to operation 1096. Operation 1096 terminates the operations of this flowchart.

Certain embodiments of the invention include just one pair of the performed operations 1092-1112 and 1102-1122, even though it is preferable in most embodiments to perform both of these pairs of operations.

FIG. 7A depicts a detail flowchart of operation 1022 of FIG. 5 further enabling address translation on the server.

Arrow 1150 directs the flow of execution from starting operation 1022 to operation 1152. Operation 1152 performs masquerading the first received message including the received destination to create a first wireline destined message including a first wireline address at the server device. Arrow 1154 directs execution from operation 1152 to operation 1156. Operation 1156 terminates the operations of this flowchart.

Arrow 1160 directs the flow of execution from starting operation 1022 to operation 1162. Operation 1162 performs demasquerading a second wireline network message including the destination address containing the network service address to create the second wireline originated message including the destination address containing the network service address. Arrow 1164 directs execution from operation 1162 to operation 1156. Operation 1156 terminates the operations of this flowchart.

FIG. 7B depicts a detail flowchart of operation 1032 of FIG. 5 further adding the network route for the wireless interface on the server.

Arrow 1190 directs the flow of execution from starting operation 1032 to operation 1192. Operation 1192 performs routing the first wireline destined message at the wireless interface based upon the network route for the server device with the network service address to create a first wireline network destined message including the first wireline address. Arrow 1194 directs execution from operation 1192 to operation 1196. Operation 1196 terminates the operations of this flowchart.

Arrow 1200 directs the flow of execution from starting operation 1032 to operation 1202. Operation 1202 performs routing a second wireline originated message including a destination containing the network service address to the server device based upon the network route for the server device with the network service address to create the second wireless destined message to the wireless client. Arrow 1204 directs execution from operation 1202 to operation 1196. Operation 1196 terminates the operations of this flowchart.

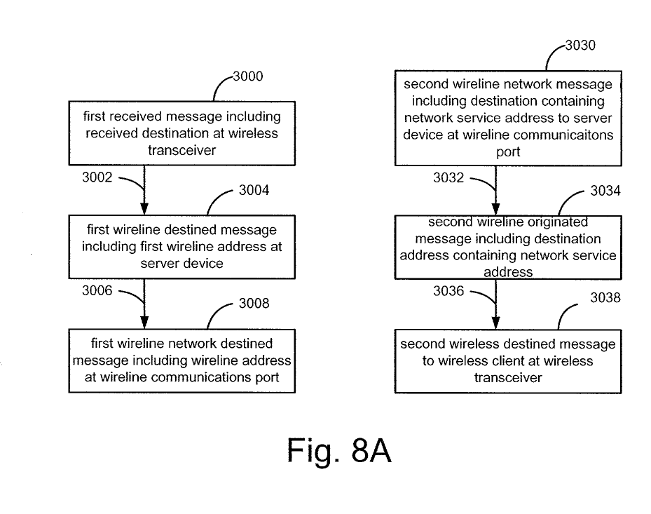

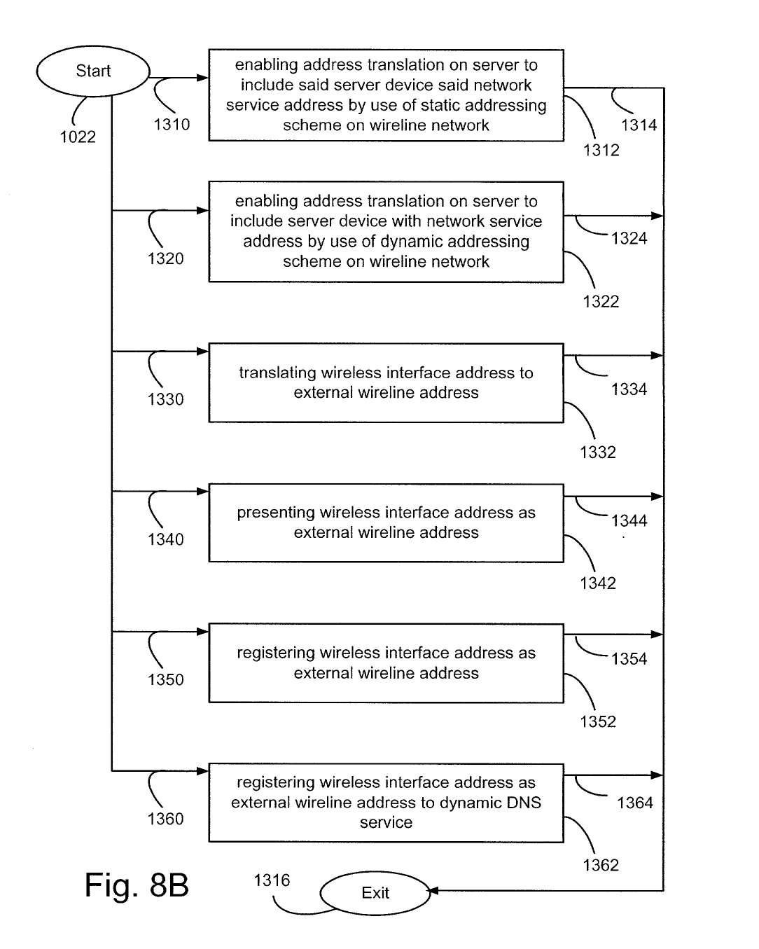

FIG. 8A depicts a portrayal of the data flow from reception of messages at the wireless transceiver and wireline communications port to the transmission of messages at the wireline communications port and wireless transceiver, respectively.

Box 3000 depicts the first received message including received destination at wireless transceiver 130. Arrow 3002 depicts the operation of masquerading to create box 3004.

Box 3004 depicts the first wireline destined message including a first wireline address at the server device. Arrow 3006 depicts the operation of routing to create box 3008.

Box 3008 depicts the first wireline network destined message including the wireline address at the wireline communications port 140.

Box 3030 depicts the second wireline network message including destination containing network service address to server device at the wireline communications port 140. Arrow 3032 depicts the operation of demasquerading to create box 3034.

Box 3034 depicts the second wireline originated message including destination address containing network service address. Arrow 3036 depicts the operation of routing to create box 3038.

Box 3038 depicts the second wireless destined message to the wireless client 200 at the wireless transceiver 130.

FIG. 8B depicts a detail flowchart of operation 1022 of FIG. 5 for enabling address translation on the server.

Arrow 1310 directs the flow of execution from starting operation 1022 to operation 1312. Operation 1312 performs enabling address translation on the server to include the server device with the network service address by use of a static addressing scheme on the wireline network. Arrow 1314 directs execution from operation 1312 to operation 1316. Operation 1316 terminates the operations of this flowchart.

Arrow 1320 directs the flow of execution from starting operation 1022 to operation 1322. Operation 1322 performs enabling address translation on the server to include the server device with the network service address by use of a dynamic addressing scheme on the wireline network. Arrow 1324 directs execution from operation 1322 to operation 1316. Operation 1316 terminates the operations of this flowchart.

Arrow 1330 directs the flow of execution from starting operation 1022 to operation 1332. Operation 1332 performs translating the wireless interface address to an external wireline address. Arrow 1334 directs execution from operation 1332 to operation 1316. Operation 1316 terminates the operations of this flowchart.

Arrow 1340 directs the flow of execution from starting operation 1022 to operation 1342. Operation 1342 performs presenting the wireless interface address as the external wireline address. Arrow 1344 directs execution from operation 1342 to operation 1316. Operation 1316 terminates the operations of this flowchart.

Arrow 1350 directs the flow of execution from starting operation 1022 to operation 1352. Operation 1352 performs registering the wireless interface address as the external wireline address. Arrow 1354 directs execution from operation 1352 to operation 1316. Operation 1316 terminates the operations of this flowchart.

Arrow 1360 directs the flow of execution from starting operation 1022 to operation 1362. Operation 1362 performs registering the wireless interface address as the external wireline address to a dynamic DNS service. Arrow 1364 directs execution from operation 1362 to operation 1316. Operation 1316 terminates the operations of this flowchart.

Note that various embodiments of the invention may include one or more of the operations of FIG. 8B.

Further note in that various embodiments of the invention, the server may be a member of the Qube product line, which includes the Qube 3, manufactured and marketed by Sun Microsystems.

The invention includes a method of producing a wireless router from a server. Certain embodiments of the invention preferably require the server to run an operating system capable of layer 3 datagram forwarding, such as Linux or FreeBSD, and have unused communications couplings on its motherboard, either in the form of bus slots or interface couplings.

FIG. 9 depicts a flowchart of operation 2000 of the method of producing a wireless router from a server.

Arrow 2010 directs the flow of execution from starting operation 2000 to operation 2012. Operation 2012 performs inserting a PCMCIA Card Reader into a server PCI/ISA slot. Arrow 2014 directs execution from operation 2012 to operation 2016. Operation 2016 terminates the operations of this flowchart.

Arrow 2020 directs the flow of execution from starting operation 2000 to operation 2022. Operation 2022 performs inserting a PCMCIA wireless LAN PC card into the Card Reader. Arrow 2024 directs execution from operation 2022 to operation 2016. Operation 2016 terminates the operations of this flowchart.

Arrow 2030 directs the flow of execution from starting operation 2000 to operation 2032. Operation 2032 performs enabling network address translation on the server. Arrow 2034 directs execution from operation 2032 to operation 2016. Operation 2016 terminates the operations of this flowchart.

Arrow 2040 directs the flow of execution from starting operation 2000 to operation 2042. Operation 2042 performs adding a network route for the wireless interface on the server. Arrow 2044 directs execution from operation 2042 to operation 2016. Operation 2016 terminates the operations of this flowchart.

Arrow 2050 directs the flow of execution from starting operation 2000 to operation 2052. Operation 2052 performs making the wireless interface address a default-route gateway on wireless clients. Arrow 2054 directs execution from operation 2052 to operation 2016. Operation 2016 terminates the operations of this flowchart.

Arrow 2060 directs the flow of execution from starting operation 2000 to operation 2062. Operation 2062 performs running DHCP on the wireless interface of the server. Arrow 2064 directs execution from operation 2062 to operation 2016. Operation 2016 terminates the operations of this flowchart.

Operation 2062 requires an entry in the DHCP configuration file of the server of the form “option routers ip_addr;” where ip_addr is the ip_addr of the wireless interface. This entry guarantees that wireless clients running a DHCP client, such as “dhcpcd” or “pump”, can configure their routing tables with a default routing entry that has ip_addr as the gateway. Address ip_addr is known to the wireless clients through DHCP offers they receive in response to their DHCP discover packets. A DHCP server runs on the server, and a DHCP client runs on every wireless client. Thus, every wireless client is fully configured to use the server by running only a standard DHCP client. No additional wireless client software is required.

Note in that various embodiments of the invention, the server may be a member of the Qube product line, which includes the Qube 3, manufactured and marketed by Sun Microsystems.

FIG. 10 depicts an alternative flowchart of operation 2000 of FIG. 9 for the method producing a wireless router from a server.

Arrow 2070 directs the flow of execution from starting operation 2000 to operation 2072. Operation 2072 performs coupling the wireless interface to the server using a member of a wireless coupling collection. Arrow 2074 directs execution from operation 2072 to operation 2076. Operation 2076 terminates the operations of this flowchart.

Arrow 2030 directs the flow of execution from starting operation 2000 to operation 2032. Operation 2032 performs enabling network address translation on the server. Arrow 2034 directs execution from operation 2032 to operation 2076. Operation 2076 terminates the operations of this flowchart.

Arrow 2040 directs the flow of execution from starting operation 2000 to operation 2042. Operation 2042 performs adding a network route for the wireless interface on the server to create a wireless interface address. Arrow 2044 directs execution from operation 2042 to operation 2076. Operation 2076 terminates the operations of this flowchart.

Arrow 2050 directs the flow of execution from starting operation 2000 to operation 2052. Operation 2052 performs making the wireless interface address a default-route gateway for a wireless user communicating via the wireless interface. Arrow 2054 directs execution from operation 2052 to operation 2076. Operation 2076 terminates the operations of this flowchart.

Arrow 2110 directs the flow of execution from starting operation 2000 to operation 2112. Operation 2112 performs running a host configuration protocol on the wireless interface by the server. Arrow 2114 directs execution from operation 2112 to operation 2076. Operation 2076 terminates the operations of this flowchart.

Note the wireless coupling collection is comprised of a bus coupling between the wireless interface and the computer as depicted in FIG. 3D, and an interface coupling between the wireless interface and the computer as depicted in FIG. 3C.

The wireless interface may be a PCMCIA wireless LAN PC card.

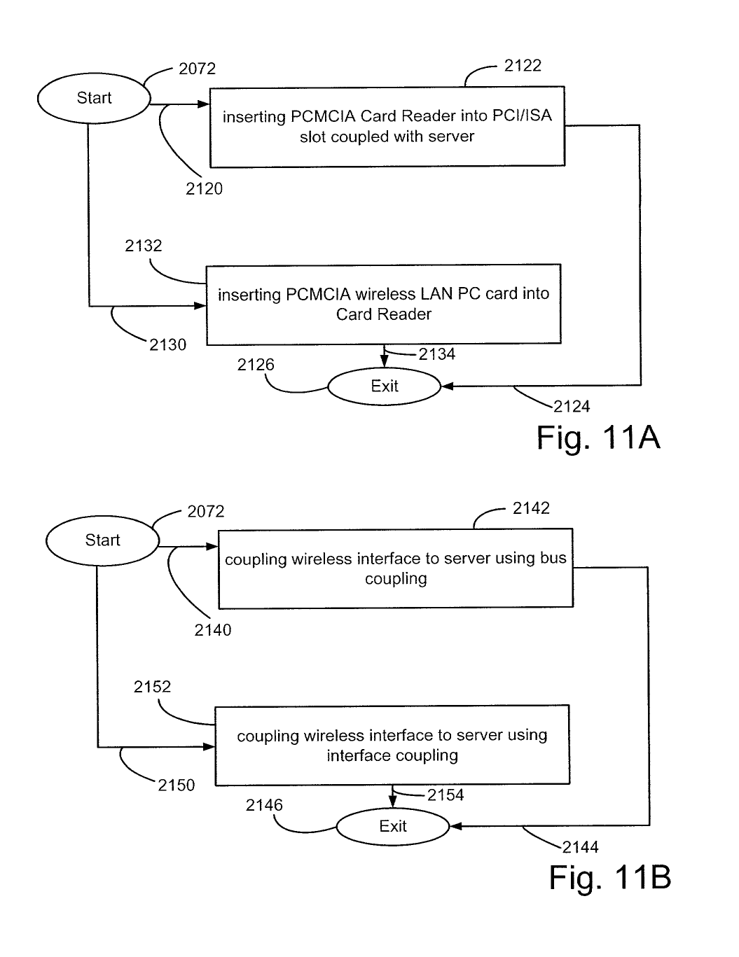

FIG. 11A depicts a detail flowchart of operation 2072 of FIG. 10 for coupling the wireless interface.

Arrow 2120 directs the flow of execution from starting operation 2072 to operation 2122. Operation 2122 performs inserting a PCMCIA Card Reader into a PCI/ISA slot coupled with the server. Arrow 2124 directs execution from operation 2122 to operation 2006. Operation 2006 terminates the operations of this flowchart.

Arrow 2130 directs the flow of execution from starting operation 2072 to operation 2132. Operation 2132 performs inserting the PCMCIA wireless LAN PC card into the Card Reader. Arrow 2134 directs execution from operation 2132 to operation 2006. Operation 2006 terminates the operations of this flowchart.

FIG. 11B depicts a detail flowchart of operation 2072 of FIG. 10 for coupling the wireless interface.

Arrow 2140 directs the flow of execution from starting operation 2072 to operation 2142. Operation 2142 performs coupling the wireless interface to the server using the bus coupling. Arrow 2144 directs execution from operation 2142 to operation 2146. Operation 2146 terminates the operations of this flowchart.

Arrow 2150 directs the flow of execution from starting operation 2072 to operation 2152. Operation 2152 performs coupling the wireless interface to the server using the interface coupling. Arrow 2154 directs execution from operation 2152 to operation 2146. Operation 2146 terminates the operations of this flowchart.

Note that various embodiments of the invention may employ at least one of the operations of FIG. 11B.

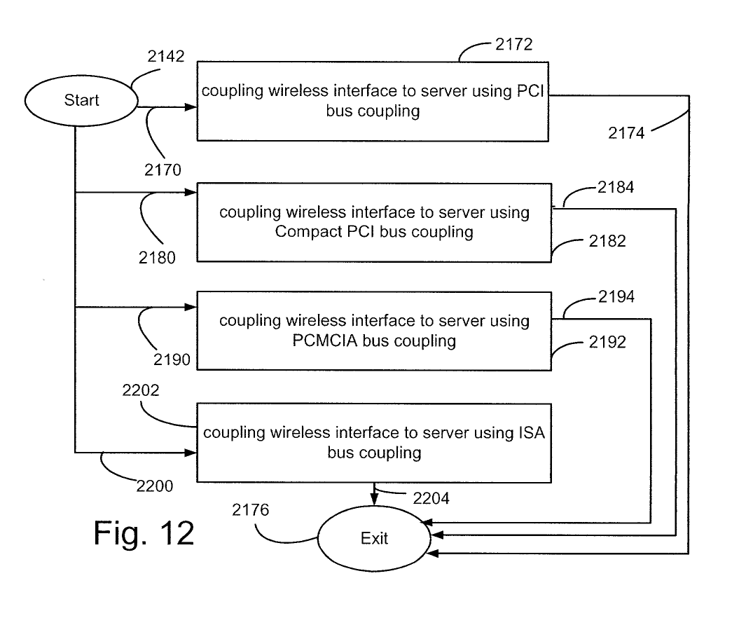

FIG. 12 depicts a detail flowchart of operation 2142 of FIG. 11B for coupling the wireless interface to the server using the bus coupling.

Arrow 2170 directs the flow of execution from starting operation 2142 to operation 2172. Operation 2172 performs coupling the wireless interface to the server using the PCI bus coupling. Arrow 2174 directs execution from operation 2172 to operation 2176. Operation 2176 terminates the operations of this flowchart.

Arrow 2180 directs the flow of execution from starting operation 2142 to operation 2182. Operation 2182 performs coupling the wireless interface to the server using the Compact PCI bus coupling. Arrow 2184 directs execution from operation 2182 to operation 2176. Operation 2176 terminates the operations of this flowchart.

Arrow 2190 directs the flow of execution from starting operation 2142 to operation 2192. Operation 2192 performs coupling the wireless interface to the server using the PCMCIA bus coupling. Arrow 2194 directs execution from operation 2192 to operation 2176. Operation 2176 terminates the operations of this flowchart.

Arrow 2200 directs the flow of execution from starting operation 2142 to operation 2202. Operation 2202 performs coupling the wireless interface to the server using the ISA bus coupling. Arrow 2204 directs execution from operation 2202 to operation 2206. Operation 2206 terminates the operations of this flowchart.

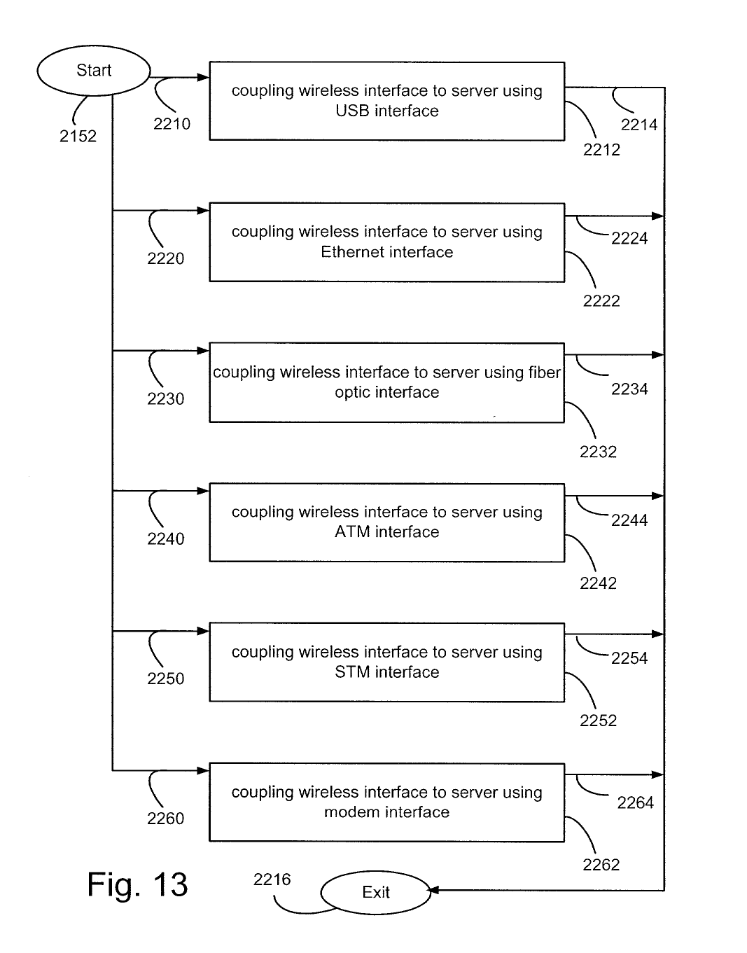

FIG. 13 depicts a detail flowchart of operation 2152 of FIG. 11B for coupling the wireless interface to the server using the interface coupling.

Arrow 2210 directs the flow of execution from starting operation 2152 to operation 2212. Operation 2212 performs coupling the wireless interface to the server using the USB interface. Arrow 2214 directs execution from operation 2212 to operation 2216. Operation 2216 terminates the operations of this flowchart.

Arrow 2220 directs the flow of execution from starting operation 2152 to operation 2222. Operation 2222 performs coupling the wireless interface to the server using the Ethernet interface. Arrow 2224 directs execution from operation 2222 to operation 2216. Operation 2216 terminates the operations of this flowchart.

Arrow 2230 directs the flow of execution from starting operation 2152 to operation 2232. Operation 2232 performs coupling the wireless interface to the server using the fiber optic interface. Arrow 2234 directs execution from operation 2232 to operation 2216. Operation 2216 terminates the operations of this flowchart.

Arrow 2240 directs the flow of execution from starting operation 2152 to operation 2242. Operation 2242 performs coupling the wireless interface to the server using the ATM interface. Arrow 2244 directs execution from operation 2242 to operation 2216. Operation 2216 terminates the operations of this flowchart.

Arrow 2250 directs the flow of execution from starting operation 2152 to operation 2252. Operation 2252 performs coupling the wireless interface to the server using the STM interface. Arrow 2254 directs execution from operation 2252 to operation 2216. Operation 2216 terminates the operations of this flowchart.

Arrow 2260 directs the flow of execution from starting operation 2152 to operation 2262. Operation 2262 performs coupling the wireless interface to the server using the modem interface. Arrow 2264 directs execution from operation 2262 to operation 2216. Operation 2216 terminates the operations of this flowchart.

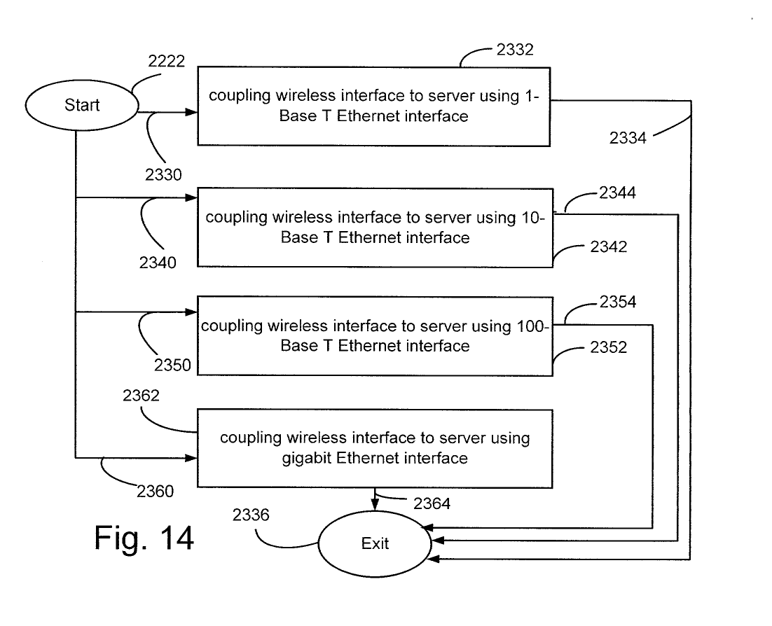

FIG. 14 depicts a detail flowchart of operation 2222 of FIG. 13 for coupling the wireless interface to the server using the Ethernet interface.

Arrow 2330 directs the flow of execution from starting operation 2222 to operation 2332. Operation 2332 performs coupling the wireless interface to the server using a 1-Base T Ethernet interface. Arrow 2334 directs execution from operation 2332 to operation 2336. Operation 2336 terminates the operations of this flowchart.

Arrow 2340 directs the flow of execution from starting operation 2222 to operation 2342. Operation 2342 performs coupling the wireless interface to the server using a 10-Base T Ethernet interface. Arrow 2344 directs execution from operation 2342 to operation 2336. Operation 2336 terminates the operations of this flowchart.

Arrow 2350 directs the flow of execution from starting operation 2222 to operation 2352. Operation 2352 performs coupling the wireless interface to the server using a 100-Base T Ethernet interface. Arrow 2354 directs execution from operation 2352 to operation 2336. Operation 2336 terminates the operations of this flowchart.

Arrow 2360 directs the flow of execution from starting operation 2222 to operation 2362. Operation 2362 performs coupling the wireless interface to the server using a gigabit Ethernet interface. Arrow 2364 directs execution from operation 2362 to operation 2336. Operation 2336 terminates the operations of this flowchart.

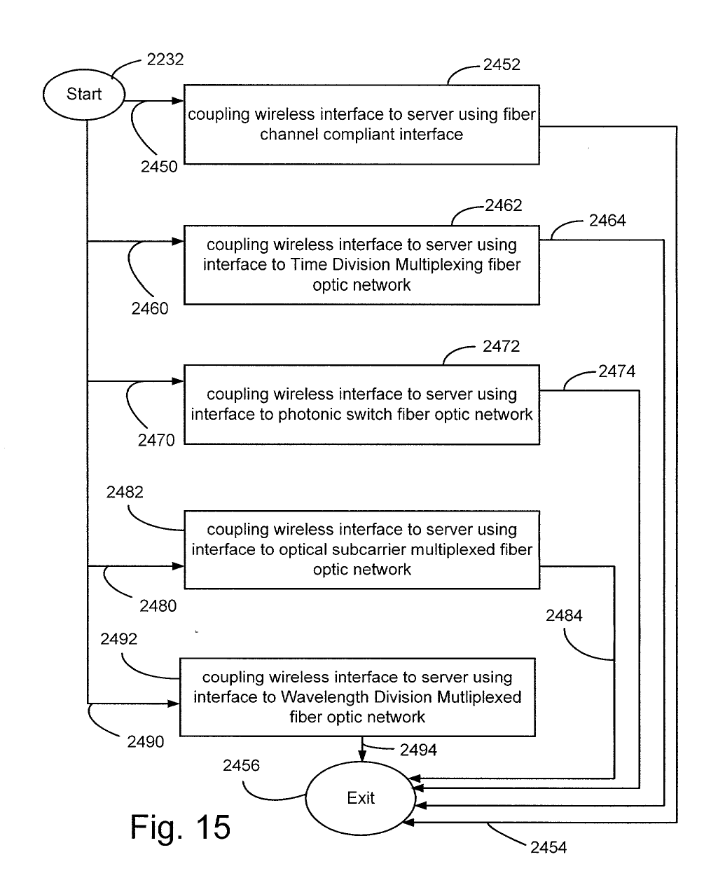

FIG. 15 depicts a detail flowchart of operation 2232 of FIG. 13 for coupling the wireless interface to the server using the fiber optic interface.

Arrow 2450 directs the flow of execution from starting operation 2232 to operation 2452. Operation 2452 performs coupling the wireless interface to the server using a fiber channel compliant interface. Arrow 2454 directs execution from operation 2452 to operation 2456. Operation 2456 terminates the operations of this flowchart.

Arrow 2460 directs the flow of execution from starting operation 2232 to operation 2462. Operation 2462 performs coupling the wireless interface to the server using an interface to a Time Division Multiplexing fiber optic network. Arrow 2464 directs execution from operation 2462 to operation 2456. Operation 2456 terminates the operations of this flowchart.

Arrow 2470 directs the flow of execution from starting operation 2232 to operation 2472. Operation 2472 performs coupling the wireless interface to the server using an interface to a photonic switch fiber optic network. Arrow 2474 directs execution from operation 2472 to operation 2456. Operation 2456 terminates the operations of this flowchart.

Arrow 2480 directs the flow of execution from starting operation 2232 to operation 2482. Operation 2482 performs coupling the wireless interface to the server using an interface to an optical subcarrier multiplexed fiber optic network. Arrow 2484 directs execution from operation 2482 to operation 2456. Operation 2456 terminates the operations of this flowchart.

Arrow 2490 directs the flow of execution from starting operation 2232 to operation 2492. Operation 2492 performs coupling the wireless interface to the server using an interface to a Wavelength Division Mutliplexed fiber optic network. Arrow 2494 directs execution from operation 2492 to operation 2456. Operation 2456 terminates the operations of this flowchart.

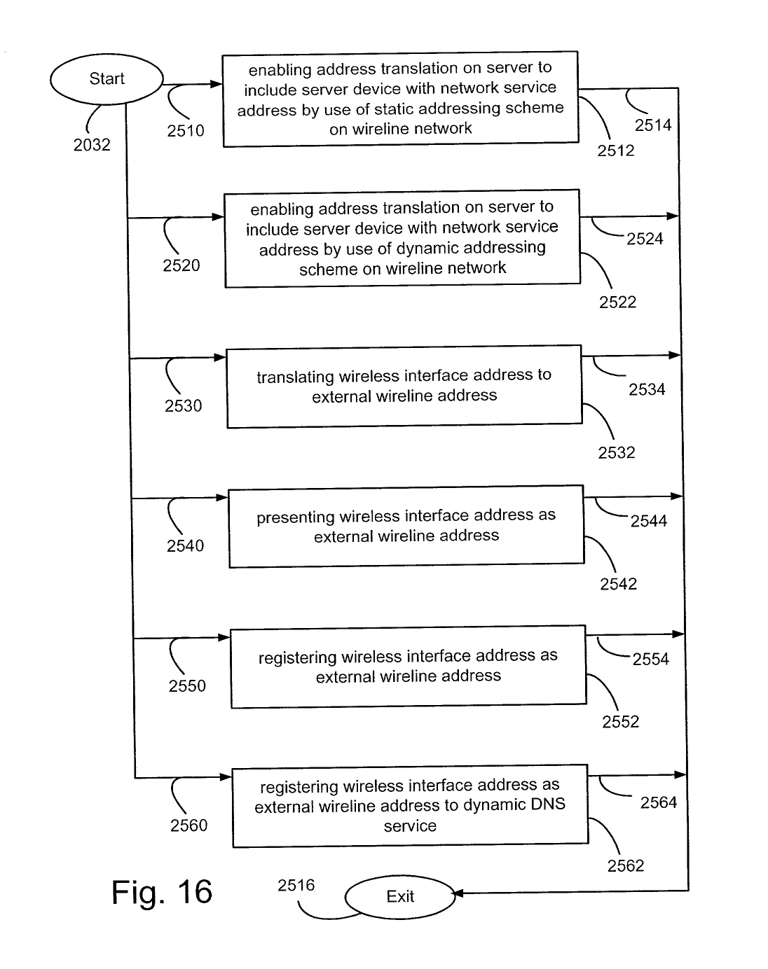

FIG. 16 depicts a detail flowchart of operation 2032 of FIGS. 9 and 10 for enabling address translation on the server.

Arrow 2510 directs the flow of execution from starting operation 2032 to operation 2512. Operation 2512 performs enabling address translation on the server to include the server device with the network service address by use of a static addressing scheme on the wireline network. Arrow 2514 directs execution from operation 2512 to operation 2516. Operation 2516 terminates the operations of this flowchart.

Arrow 2520 directs the flow of execution from starting operation 2032 to operation 2522. Operation 2522 performs enabling address translation on the server to include the server device with the network service address by use of a dynamic addressing scheme on the wireline network. Arrow 2524 directs execution from operation 2522 to operation 2516. Operation 2516 terminates the operations of this flowchart.

Arrow 2530 directs the flow of execution from starting operation 2032 to operation 2532. Operation 2532 performs translating the wireless interface address to an external wireline address. Arrow 2534 directs execution from operation 2532 to operation 2516. Operation 2516 terminates the operations of this flowchart.

Arrow 2540 directs the flow of execution from starting operation 2032 to operation 2542. Operation 2542 performs presenting the wireless interface address as the external wireline address. Arrow 2544 directs execution from operation 2542 to operation 2516. Operation 2516 terminates the operations of this flowchart.

Arrow 2550 directs the flow of execution from starting operation 2032 to operation 2552. Operation 2552 performs registering the wireless interface address as the external wireline address. Arrow 2554 directs execution from operation 2552 to operation 2516. Operation 2516 terminates the operations of this flowchart.

Arrow 2560 directs the flow of execution from starting operation 2032 to operation 2562. Operation 2562 performs registering the wireless interface address as the external wireline address to a dynamic DNS service. Arrow 2564 directs execution from operation 2562 to operation 2516. Operation 2516 terminates the operations of this flowchart.

Note that various embodiments of the invention may use one or more of the operations of FIG. 16.

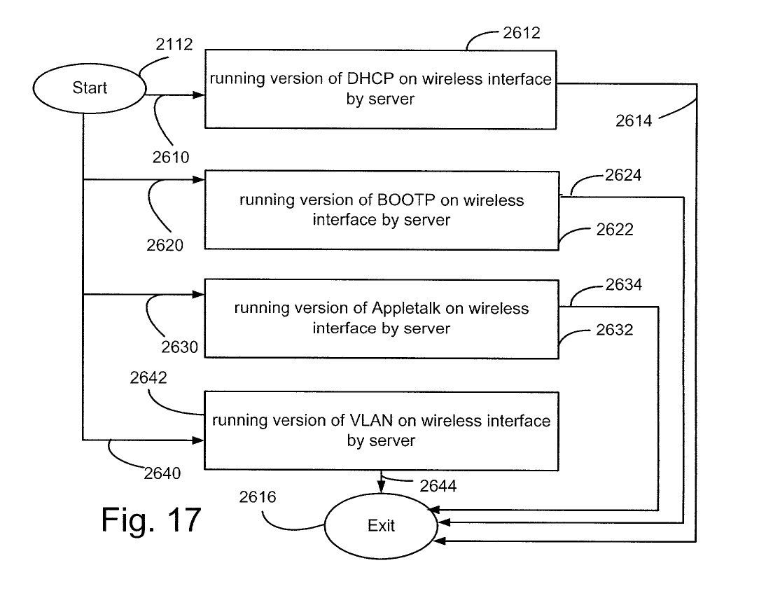

FIG. 17 depicts a detail flowchart of operation 2112 of FIG. 10 for running the host configuration protocol.

Arrow 2610 directs the flow of execution from starting operation 2112 to operation 2612. Operation 2612 performs running a version of DHCP on the wireless interface by the server. Arrow 2614 directs execution from operation 2612 to operation 2616. Operation 2616 terminates the operations of this flowchart.

Arrow 2620 directs the flow of execution from starting operation 2112 to operation 2622. Operation 2622 performs running a version of BOOTP on the wireless interface by the server. Arrow 2624 directs execution from operation 2622 to operation 2616. Operation 2616 terminates the operations of this flowchart.

Arrow 2630 directs the flow of execution from starting operation 2112 to operation 2632. Operation 2632 performs running a version of Appletalk on the wireless interface by the server. Arrow 2634 directs execution from operation 2632 to operation 2616. Operation 2616 terminates the operations of this flowchart.

Arrow 2640 directs the flow of execution from starting operation 2112 to operation 2642. Operation 2642 performs running a version of VLAN on the wireless interface by the server. Arrow 2644 directs execution from operation 2642 to operation 2616. Operation 2616 terminates the operations of this flowchart.

Note that various embodiments of the invention may use an operation of FIG. 17.

The preceding embodiments have been provided by way of example and are not meant to constrain the scope of the following claims.

1. A wireless router supporting communications between a wireless client and a wireline network comprising:
at least one computer operating as a server based upon a program system comprising program steps residing in memory accessibly coupled with said computer;
said wireline network coupled to said server via a wireline communications port;
a wireless interface coupled to said server by a member of a wireless coupling collection and said wireless interface possessing a wireless transceiver;
wherein said wireless coupling collection is comprised of a bus coupling between said wireless interface and said server, and an interface coupling between said wireless interface and said server;
wherein said bus coupling includes at least a member of the bus coupling collection comprising a PCI bus coupling, a Compact PCI bus coupling, and an ISA bus coupling;
wherein said interface coupling includes at least one member of the interface coupling collection comprising a USB interface, an Ethernet interface, a fiber optic interface, an ATM interface, a STM interface, and a modem interface;
wherein said Ethernet interface includes at least a member of the collection comprising a 1-Base T Ethernet interface, a 10-Base T Ethernet interface, a 100-Base T Ethernet interface, and a gigabit Ethernet interface;
wherein said fiber optic interface includes at least a member of the collection comprising a fiber channel compliant interface, an interface to a Time Division Multiplexing fiber optic network, an interface to a photonic switch fiber optic network, an interface to an optical subcarrier multiplexed fiber optic network and an interface to Wavelength Division Mutliplexed fiber optic network;
wherein said program system is comprised of the program steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network;
a wireless client communicating via said wireless coupling based upon a login protocol accessing a client authorization list to create an authorized client; and
said authorized client communicating via said wireless coupling using said network route to communicate with said wireline network via said wireline communications port;
wherein the program step making said wireless interface available to said wireless client is further comprised of the program steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the program step enabling address translation on said server is further comprised of the program steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the program step adding said network route for said wireless interface on said server is further comprised of the program steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client;
wherein said wireless transceiver further supports at least the IEEE 802.11b messaging protocol standard in communicating with said wireless client.

2. The wireless router of claim 1,
wherein said wireless interface further supports at least the IEEE 802.11a messaging protocol standard in communicating with said wireless client.

3. The wireless router of claim 1,
wherein said wireless interface further supports at least a layer three messaging protocol in communicating with said wireless client including said server supporting layer three datagrams.

4. The wireless router of claim 3,
wherein said wireless interface further supports a messaging protocol compatible with WAP in communicating with said wireless client.

5. The wireless router of claim 1,
wherein the program step enabling address translation on said server is further comprised of at least one member of the collection comprising the program steps of:
enabling address translation on said server to include said server device with said network service address by use of a static addressing scheme on said wireline network;
enabling address translation on said server to include said server device with said network service address by use of a dynamic addressing scheme on said wireline network;
translating said wireless interface address to an external wireline address;
presenting said wireless interface address as said external wireline address;
registering said wireless interface address as said external wireline address; and
registering said wireless interface address as said external wireline address to a dynamic DNS service.

6. A method of providing communication between a wireless transceiver and a wireline network, wherein a wireless interface possessing a wireline communications port and said wireless transceiver is coupled to a server by a member of a wireless coupling collection, wherein said server is further coupled to said wireline network comprising the steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network; and
a wireless client communicating via said wireless coupling based upon a login protocol accessing a client authorization list to create an authorized client; and
said authorized client communicating via said wireless coupling using said network route to communicate with said wireline network; and
wherein the step making said wireless interface available to said wireless client is further comprised of the steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the step enabling address translation on said server is further comprised of the steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the step adding said network route for said wireless interface on said server is further comprised of the steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client;
wherein said wireless transceiver further supports at least the IEEE 802.11b messaging protocol standard in communicating with said wireless client;
wherein said wireless coupling collection is comprised of a bus coupling between said wireless interface and said server, and an interface coupling between said wireless interface and said server;
wherein said bus coupling includes at least a member of the bus coupling collection comprising a PCI bus coupling, a Compact PCI bus coupling, and an ISA bus coupling;
wherein said interface coupling includes at least one member of the interface coupling collection comprising a USB interface, an Ethernet interface, a fiber optic interface, an ATM interface, a STM interface, and a modem interface;
wherein said Ethernet interface includes at least a member of the collection comprising a 1-Base T Ethernet interface, a 11-Base T Ethernet interface, a 110 Base T Ethernet interface, and a gigabit Ethernet interface; and
wherein said fiber optic interface includes at least a member of the collection comprising a fiber channel compliant interface, an interface to a Time Division Multiplexing fiber optic network, an interface to a photonic switch fiber optic network, an interface to an optical subcarrier multiplexed fiber optic network and an interface to Wavelength Division Mutliplexed fiber optic network.

7. The method of claim 6, wherein said first wireline network destined messages include said wireline address.

8. The method of claim 6, wherein said second wireless destined messages are sent to said authorized client.

9. The method of claim 6,
wherein said wireless transceiver further supports at least the IEEE 802.11a messaging protocol standard in communicating with said wireless client.

10. The method of claim 6,
wherein said wireless transceiver further supports at least a layer three messaging protocol in communicating with said wireless client including said server supporting layer three datagrams.

11. The method of claim 10,
wherein said wireless transceiver further supports a messaging protocol compatible with WAP in communicating with said wireless client.

12. A program system implementing the steps of the method of claim 6 as program steps residing in at least one memory accessibly coupled with a computer operating said server;
wherein said memory includes at least one member of the collection comprising
a non-volatile memory component accessibly coupled with said computer,
a volatile memory component accessibly coupled with said computer, and
a removable non-volatile memory component inserted into a memory component reader coupled with said computer forming an accessible coupling of said removable non-volatile memory component with said computer.

13. An upgrade package containing a version of a program system implementing the steps of the method of claim 6 as program steps to reside in at least one memory accessibly coupled with a computer operating said server.

14. The upgrade package of claim 13,
wherein said upgrade package is accessibly coupled with an upgrade server communicatively accessible to said computer operating said server, said upgrade server providing said upgrade package to said computer.

15. The upgrade package of claim 14,
wherein said upgrade server is operated by a method including the steps of:
establishing communications between said upgrade server and said server; and
transmitting said upgrade package to said server via said communications to provide said upgrade package to said server;
wherein said server is operated by a method including the steps of:
receiving said provided upgrade package from said upgrade server to create a received upgrade package; and
processing said received upgrade package to create said program system.

16. The method of claim 6,
wherein the step enabling address translation on said server is further comprised of at least one member of the collection comprising the steps of:
enabling address translation on said server to include said server device with said network service address by use of a static addressing scheme on said wireline network;
enabling address translation on said server to include said server device with said network service address by use of a dynamic addressing scheme on said wireline network;
translating said wireless interface address to an external wireline address;
presenting said wireless interface address as said external wireline address;
registering said wireless interface address as said external wireline address; and
registering said wireless interface address as said external wireline address to a dynamic DNS service.

17. A method of providing communication between a wireless transceiver and a wireline network, wherein a wireless interface possessing said wireless transceiver is coupled to a server further coupled via a wireline communications port to said wireline network, comprising the steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network.

18. The method of claim 17, further comprising the steps of:
a wireless client communicating via said wireless coupling based upon a login protocol accessing a client authorization list to create an authorized client; and
said authorized client communicating via said wireless coupling using said network route to communicate with said wireline network.

19. The method of claim 17,
wherein the step making said wireless interface available to said authorized client is further comprised of the steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the step enabling address translation on said server is further comprised of the steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the step adding said network route for said wireless interface on said server is further comprised of the steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client.

20. The method of claim 17,
wherein said wireless interface supports a message passing communications protocol in communicating with said wireless client.

21. The method of claim 20,
wherein said wireless transceiver further supports at least a layer two messaging protocol in communicating with said wireless client.

22. The method of claim 21,
wherein said wireless transceiver further supports at least the IEEE 802.11b messaging protocol standard in communicating with said wireless client.

23. The method of claim 21,
wherein said wireless transceiver further supports at least the IEEE 802.11a messaging protocol standard in communicating with said wireless client.

24. The method of claim 21,
wherein said wireless interface further supports at least a layer three messaging protocol in communicating with said wireless client including said server supporting layer three datagrams.

25. The method of claim 24,
wherein said wireless transceiver further supports a messaging protocol compatible with WAP in communicating with said wireless client.

26. A program system implementing the steps of the method of claim 17 as program steps residing in at least one memory accessibly coupled with a computer operating said server;
wherein said memory includes at least one member of the collection comprising
a non-volatile memory component accessibly coupled with said computer,
a volatile memory component accessibly coupled with said computer, and
a removable non-volatile memory component inserted into a memory component reader coupled with said computer forming an accessible coupling of said removable non-volatile memory component with said computer.

27. An upgrade package containing a version of a program system implementing the steps of the method of claim 17 as program steps to reside in at least one memory accessibly coupled with a computer operating said server.

28. The upgrade package of claim 27,
wherein said upgrade package is accessibly coupled with an upgrade server communicatively accessible to said computer operating said server, said upgrade server providing said upgrade package to said computer.

29. The upgrade package of claim 28,
wherein said upgrade server is operated by a method including the steps of:
establishing communications between said upgrade server and said server; and
transmitting said upgrade package to said server via said communications to provide said upgrade package to said server;
wherein said server is operated by a method including the steps of:
receiving said provided upgrade package from said upgrade server to create a received upgrade package; and
processing said received upgrade package to create said program system.

30. The method of claim 17,
wherein the step enabling address translation on said server is further comprised of at least one member of the collection comprising the steps of:
enabling address translation on said server to include said server device with said network service address by use of a static addressing scheme on said wireline network;
enabling address translation on said server to include said server device with said network service address by use of a dynamic addressing scheme on said wireline network;
translating said wireless interface address to an external wireline address;
presenting said wireless interface address as said external wireline address;
registering said wireless interface address as said external wireline address; and
registering said wireless interface address as said external wireline address to a dynamic DNS service.

31. A wireless router supporting communications between a wireless client and a wireline network comprising:
at least one computer operating a server based upon a program system comprising program steps residing in memory accessibly coupled with said computer;
said wireline network coupled to said server via a wireline communications port;
a wireless interface coupled to said computer by a member of a wireless coupling collection and said wireless interface possessing wireless transceiver;
wherein said wireless coupling collection is comprised of a bus coupling between said wireless interface and said computer, and an interface coupling between said wireless interface and said computer;
wherein said program system is comprised of the program steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network.

32. The wireless router of claim 31,
wherein said program system further comprising the program steps of:
a wireless client communicating via said wireless coupling based upon a login protocol accessing a client authorization list to create an authorized client; and
said authorized client communicating via said wireless coupling using said network route to communicate with said wireline network.

33. The wireless router of claim 31,
wherein the program step making said wireless interface available to said wireless client is further comprised of the program steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the program step enabling address translation on said server is further comprised of the program steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the program step adding said network route for said wireless interface on said server is further comprised of the program steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client.

34. The wireless router of claim 31,
wherein said wireless interface supports a message passing communications protocol in communicating with said wireless client.

35. The wireless router of claim 34,
wherein said wireless transceiver further supports at least a layer two messaging protocol in communicating with said wireless client.

36. The wireless router of claim 35,
wherein said wireless interface further supports at least the IEEE 802.11b messaging protocol standard in communicating with said wireless client.

37. The wireless router of claim 35,
wherein said wireless interface further supports at least the IEEE 802.11a messaging protocol standard in communicating with said wireless client.

38. The wireless router of claim 35,
wherein said wireless interface further supports at least a layer three messaging protocol in communicating with said wireless client including said server supporting layer three datagrams.

39. The wireless router of claim 38,
wherein said wireless interface further supports a messaging protocol compatible with WAP in communicating with said wireless client.

40. The wireless router of claim 31,
wherein said bus coupling includes at least a member of the bus coupling collection comprising a PCI bus coupling, a Compact PCI bus coupling, and an ISA bus coupling.

41. The wireless router of claim 31,
wherein said interface coupling includes at least one member of the interface coupling collection comprising a USB interface, an Ethernet interface, a fiber optic interface, an ATM interface, a STM interface, and a modem interface.

42. The wireless router of claim 41,
wherein said Ethernet interface includes at least a member of the collection comprising a 1-Base T Ethernet interface, a 10-Base T Ethernet interface, a 100-Base T Ethernet interface, and a gigabit Ethernet interface.

43. The wireless router of claim 41,
wherein said fiber optic interface includes at least a member of the collection comprising a fiber channel compliant interface, an interface to a Time Division Multiplexing fiber optic network, an interface to a photonic switch fiber optic network, an interface to an optical subcarrier multiplexed fiber optic network and an interface to Wavelength Division Mutliplexed fiber optic network.

44. A wireless router supporting communications between a wireless client and a wireline network comprising:
said wireline network coupled to a server via a wireline communications port;
a wireless interface coupled to said server by a member of a wireless coupling collection and possessing a wireless transceiver;
wherein said wireless coupling collection is comprised of a bus coupling between said wireless interface and said server, and an interface coupling between said wireless interface and said server;
wherein said bus coupling includes at least a member of the bus coupling collection comprising a PCI bus coupling, a Compact PCI bus coupling, and an ISA bus coupling;
wherein said interface coupling includes at least one member of the interface coupling collection comprising a USB interface, an Ethernet interface, a fiber optic interface, an ATM interface, a STM interface, and a modem interface;
wherein said Ethernet interface includes at least a member of the collection comprising a 1-Base T Ethernet interface, a 10-Base T Ethernet interface, a 100-Base T Ethernet interface, and a gigabit Ethernet interface;
wherein said fiber optic interface includes at least a member of the collection comprising a fiber channel compliant interface, an interface to a Time Division Multiplexing fiber optic network, an interface to a photonic switch fiber optic network, an interface to an optical subcarrier multiplexed fiber optic network and an interface to Wavelength Division Mutliplexed fiber optic network;
wherein said server is comprised of:
a means for coupling said wireless interface to said wireline network via said wireline communications port as a server device with a network service address;
a means for enabling address translation on said server to include said server device with said network service address;
a means for adding a network route for said wireless interface on said server for said server device with said network service address; and
a means for making said wireless interface available to at least one wireless client communicating via said wireless coupling as a gateway to communicate on said wireline network;
a means for a wireless client communicating via said wireless coupling based upon a login protocol accessing a client authorization list to create an authorized client; and
a means for said authorized client communicating via said wireless coupling using said network route to communicate with said wireline network;
wherein said means for making said wireless interface available to said wireless client is further comprised of:
a means for said wireless transceiver receiving a first message including a destination from said wireless client to create a first received message including said received destination at said wireless transceiver;
a means for said wireless transceiver transmitting a second wireless destined message to said wireless client;
a means for transmitting said first wireline network destined message including said wireline address via said wireline communications port; and
a means for receiving a second wireline network message including a destination containing said network service address to create a second wireline network message including said destination containing said network service address to said server device;
wherein said means for enabling address translation on said server is further comprised of:
a means for masquerading said first received message including said received destination to create a first wireline destined message including a first wireline address at said server device; and
a means for demasquerading a second wireline network message including said destination address containing said network service address to create said second wireline originated message including said destination address containing said network service address;
wherein said means for adding said network route for said wireless interface on said server is further comprised of:
a means for routing said first wireline destined message at said wireless interface based upon said network route for said server device with said network service address to create a first wireline network destined message including said first wireline address; and
a means for routing a second wireline originated message including a destination containing said network service address to said server device based upon said network route for said server device with said network service address to create said second wireless destined message to said wireless client;
wherein said wireless transceiver further supports at least the IEEE 802.11b messaging protocol standard in communicating with said wireless client.

45. The wireless router of claim 44,
wherein said wireless interface further supports at least the IEEE 802.11a messaging protocol standard in communicating with said wireless client.

46. The wireless router of claim 44,
wherein said wireless interface further supports at least a layer three messaging protocol in communicating with said wireless client including said server supporting layer three datagrams.

47. The wireless router of claim 46,
wherein said wireless interface further supports a messaging protocol compatible with WAP in communicating with said wireless client.

48. The method of claim 44,
wherein said means for enabling address translation on said server is further comprised of at least one member of the collection comprising:
a means for enabling address translation on said server to include said server device with said network service address by use of a static addressing scheme on said wireline network;
a means for enabling address translation on said server to include said server device with said network service address by use of a dynamic addressing scheme on said wireline network;
a means for translating said wireless interface address to an external wireline address;
a means for presenting said wireless interface address as said external wireline address;
a means for registering said wireless interface address as said external wireline address; and
a means for registering said wireless interface address as said external wireline address to a dynamic DNS service.

49. A method of producing a wireless router from a server comprising the steps of:
coupling said wireless interface to said server using a member of a wireless coupling collection;
enabling network address translation on said server;
adding a network route for said wireless interface on said server to create a wireless interface address;
making said wireless interface address a default-route gateway for a wireless user communicating via said wireless interface; and
running a host configuration protocol on said wireless interface by said server;
wherein said wireline network is coupled to a server via a wireline communications port;
wherein said wireless coupling collection is comprised of a bus coupling between said wireless interface and said computer, and an interface coupling between said wireless interface and said computer;
wherein said bus coupling includes at least a member of the bus coupling collection comprising a PCI bus coupling, a Compact PCI bus coupling, and an ISA bus coupling;
wherein said interface coupling includes at least one member of the interface coupling collection comprising a USB interface, an Ethernet interface, a fiber optic interface, an ATM interface, a STM interface, and a modem interface;
wherein said Ethernet interface includes at least a member of the collection comprising a 1-Base T Ethernet interface, a 10-Base T Ethernet interface, a 100-Base T Ethernet interface, and a gigabit Ethernet interface;
wherein said fiber optic interface includes at least a member of the collection comprising an fiber channel compliant interface, an interface to a Time Division Multiplexing fiber optic network, an interface to a photonic switch fiber optic network, an interface to an optical subcarrier multiplexed fiber optic network and an interface to Wavelength Division Mutliplexed fiber optic network.

50. The method of claim 49,
wherein said wireless interface is a PCMCIA wireless LAN PC card;
wherein the step coupling said wireless interface is further comprised of the steps of:
inserting a PCMCIA Card Reader into a PCI/ISA slot coupled with said server; and
inserting said PCMCIA wireless LAN PC card into said Card Reader.

51. The method of claim 49,
wherein the step coupling said wireless interface is comprised of at least one member of the collection comprising the steps of:
coupling said wireless interface to said server using said bus coupling; and
coupling said wireless interface to said server using said interface coupling.

52. The method of claim 51,
wherein the step coupling said wireless interface to said server using said bus coupling is further comprised of at least one member of the collection comprising the steps of:
coupling said wireless interface to said server using said PCI bus;
coupling said wireless interface to said server using said Compact PCI bus; and
coupling said wireless interface to said server using said ISA bus.

53. The method of claim 51,
wherein the step coupling said wireless interface to said server using said interface coupling is further comprised of at least one member of the collection comprising the steps of:
coupling said wireless interface to said server using said USB interface;
coupling said wireless interface to said server using said Ethernet interface;
coupling said wireless interface to said server using said fiber optic interface;
coupling said wireless interface to said server using said ATM interface;
coupling said wireless interface to said server using said STM interface; and
coupling said wireless interface to said server using said modem interface.

54. The method of claim 51,
wherein the step coupling said wireless interface to said server using said Ethernet interface is further comprised of at least one member of the collection comprising the steps of:
coupling said wireless interface to said server using a 1-Base T Ethernet interface;
coupling said wireless interface to said server using a 10-Base T Ethernet interface;
coupling said wireless interface to said server using a 100-Base T Ethernet interface;
coupling said wireless interface to said server using a gigabit Ethernet interface.

55. The method of claim 51,
wherein the step coupling said wireless interface to said server using said fiber optic interface is further comprised of at least a member of the collection comprising the steps of:
coupling said wireless interface to said server using a fiber channel compliant interface;
coupling said wireless interface to said server using an interface to a Time Division Multiplexing fiber optic network;
coupling said wireless interface to said server using an interface to a photonic switch fiber optic network;
coupling said wireless interface to said server using an interface to an optical subcarrier multiplexed fiber optic network; and
coupling said wireless interface to said server using an interface to a Wavelength Division Mutliplexed fiber optic network.

56. The method of claim 49,
wherein the step enabling address translation on said server is further comprised of at least one member of the collection comprising the steps of:
enabling address translation on said server to include said server device with said network service address by use of a static addressing scheme on said wireline network;
enabling address translation on said server to include said server device with said network service address by use of a dynamic addressing scheme on said wireline network;
translating said wireless interface address to an external wireline address;
presenting said wireless interface address as said external wireline address;
registering said wireless interface address as said external wireline address; and
registering said wireless interface address as said external wireline address to a dynamic DNS service.

57. The method of claim 49,
wherein the step running said host configuration protocol is further comprised of a member of the collection comprising the steps of
running a version of DHCP on said wireless interface by said server;
running a version of BOOTP on said wireless interface by said server;
running a version of Appletalk on said wireless interface by said server; and
running a version of VLAN on said wireless interface by said server.

58. A wireless router supporting communications between a wireless client and a wireline network comprising:
a wireless interface coupled to a server and possessing a wireless transceiver;
said wireline network coupled to said server via a wireline communications port;
at least one computer operating said server based upon a program system comprising program steps residing in memory accessibly coupled with said computer;
wherein said program system is comprised of the program steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network
wherein said server is a member of the Sun Qube product collection comprising at least a Qube 3.

59. The wireless router of claim 58,
wherein said wireless interface is a radio network interface.

60. A method of providing communication between a wireless transceiver and a wireline network, wherein a wireless interface possessing said wireless transceiver is coupled to a server further coupled via a wireline communications port to said wireline network, comprising the steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network;
wherein said server is a member of a Sun Qube product collection comprising at least a Qube 3.

61. The method of claim 60,
wherein said wireless interface is a radio network interface.
